(19) United States
(12) Patent Application Publication
(10) Pub. No.: US 2026/0188148 A1
(43) Pub. Date: Jul. 2, 2026

(54) ELECTRONIC DEVICE FOR CONTROLLING MIRROR DISPLAY AND METHOD OF OPERATING THE ELECTRONIC DEVICE

(71) Applicant: SAMSUNG ELECTRONICS CO., LTD., Suwon-si (KR)

(72) Inventors: Hyeryoung CHOI, Suwon-si (KR); Seungki CHO, Suwon-si (KR); Changwoo LEE, Suwon-si (KR)

(73) Assignee: SAMSUNG ELECTRONICS CO., LTD., Suwon-si (KR)

(21) Appl. No.: 19/259,773

(22) Filed: Jul. 3, 2025

Related U.S. Application Data
(63) Continuation of application No. PCT/KR2025/008784, filed on Jun. 24, 2025.

(30) Foreign Application Priority Data
Nov. 15, 2024 (KR) 10-2024-0163364

(51) Int. Cl. G09G 3/00; G06V 40/10

(52) U.S. Cl. CPC G09G 3/001; G06V 40/10; G09G 2320/0606; G09G 2320/0613; G09G 2320/0686; G09G 2354/00; G09G 2360/144

(57) ABSTRACT

Provided is an electronic device and method of operating same. The electronic device includes: a mirror display including a display region; memory storing at least one instruction; and at least one processor including processing circuitry, wherein the at least one processor is configured to individually or collectively execute the at least one instruction, and wherein the at least one instruction, when executed by the at least one processor individually or collectively, cause the electronic device to: identify a proportion of the display region occupied by a content region, and control a brightness of the display region based on the proportion.

### CROSS-REFERENCE TO RELATED APPLICATIONS

This application is a by-pass continuation of International Application No. PCT/KR2025/008784, filed on Jun. 24, 2025, which is based on and claims priority to Korean Patent Application No. 10-2024-0163364, filed in the Korean Intellectual Property Office on Nov. 15, 2024, the disclosures of which are incorporated by reference herein in their entireties.

### BACKGROUND

### 1. Field

The disclosure relates to an electronic device and method of operating the electronic device. More particularly, the disclosure relates to an electronic device for controlling a mirror display and a method of operating the electronic device.

### 2. Description of Related Art

As technologies advance, various types of electronic devices are emerging and digital experiences in daily lives of users are expanding. A mirror display is a device in which a mirror is coupled with a display panel. An electronic device including the mirror display may not only perform a mirror-specific function of reflecting the shape of an object by using reflection of light but may also output various information such as weather, calendar, images and main news.

The electronic device including the mirror display may control brightness or reflectivity of the display depending on the purpose of use. For example, the electronic device including the mirror display may be controlled to increase information readability by increasing brightness when the electronic device is primarily used for displaying information or to increase reflectivity so that the user is able to see himself/herself clearly when the mirror function is primarily used.

### SUMMARY

Provided is an electronic device for controlling a mirror display and a method of operating the electronic device.

According to an aspect of the disclosure, an electronic device includes: a mirror display including a display region; memory storing at least one instruction; and at least one processor including processing circuitry, and wherein the at least one instruction, when executed by the at least one processor individually or collectively, cause the electronic device to: identify a proportion of the display region occupied by a content region, and control a brightness of the display region based on the proportion.

According to an aspect of the disclosure, a method of operating an electronic device includes: identifying a proportion of a display region of a mirror display occupied by a content region; and controlling a brightness of the display region based on the proportion.

According to an aspect of the disclosure, a non-transitory computer-readable medium has at least one instruction recorded therein, which when executed by at least one processor of an electronic device, causes the electronic device to perform a method of operating the electronic device, the method include: identifying a proportion of a display region of a mirror display occupied by a content region; and controlling a brightness of the display region based on the proportion.

### BRIEF DESCRIPTION OF THE DRAWINGS

The above and other aspects and features of certain embodiments of the present disclosure will be more apparent from the following detailed descriptions taken in conjunction with the accompanying drawings, in which:

FIG. 1 is a reference diagram illustrating an example of an electronic device for controlling a mirror display, according to an embodiment of the disclosure;

FIG. 2 is a block diagram illustrating a configuration of an electronic device, according to an embodiment of the disclosure;

FIG. 3 is a flowchart illustrating a method of controlling a mirror display, according to an embodiment of the disclosure;

FIG. 4A is a flowchart for describing details of an operation shown in FIG. 3 of controlling brightness of a display region on a mirror display based on a proportion occupied by a content region in the display region, according to an embodiment of the disclosure;

FIG. 4B is a reference diagram for describing an example of controlling brightness of a display region on a mirror display based on a proportion occupied by a content region in the display region, according to an embodiment of the disclosure;

FIG. 5A is a flowchart illustrating a method of controlling brightness of a person area on a mirror display or an area other than the person area, according to an embodiment of the disclosure;

FIG. 5B is a reference diagram for describing an example of controlling brightness of a person area on a mirror display or an area other than the person area, according to an embodiment of the disclosure;

FIG. 6A is a flowchart for describing details of an operation of FIG. 5A of identifying a person area projected onto the mirror display, according to an embodiment of the disclosure;

FIG. 6B is a reference diagram for describing an example of an operation of FIG. 6A of obtaining an image projected onto the mirror display based on an image obtained by a camera, according to an embodiment of the disclosure;

FIG. 7A is a flowchart illustrating a method of controlling brightness of a display region on a mirror display based on a sensor value obtained by an ambient light sensor, according to an embodiment of the disclosure;

FIG. 7B is a flowchart for describing details of an operation of FIG. 7A of controlling brightness of the display region on the mirror display based on the sensor value obtained by the ambient light sensor, according to an embodiment of the disclosure;

FIG. 8A is a flowchart illustrating a method of controlling brightness of a content region and an area other than the content region, according to an embodiment of the disclosure;

FIG. 8B is a reference diagram for describing an example of controlling brightness of a content region and an area other than the content region, according to an embodiment of the disclosure;

FIG. 9A is a reference diagram for describing relations between brightness and reflectivity of a mirror display, according to an embodiment of the disclosure;

FIG. 9B is a reference diagram for briefly describing a principle of a mirror display, according to an embodiment of the disclosure;

FIG. 10A is a flowchart illustrating a method of controlling a mirror display based on a user input, according to an embodiment of the disclosure;

FIG. 10B is a reference diagram for describing an example of controlling a mirror display based on a user input, according to an embodiment of the disclosure;

FIG. 11 is a flowchart illustrating a method of controlling a mirror display based on a person being identified in an image, according to an embodiment of the disclosure;

FIG. 12 is a reference diagram for describing an example of controlling an electronic device for each section, according to an embodiment of the disclosure; and

FIG. 13 is a block diagram illustrating a configuration of an electronic device, according to an embodiment of the present disclosure.

### DETAILED DESCRIPTION

It is understood that the embodiments of the disclosure described herein, and associated terms used herein, are not intended to limit technical features herein to particular embodiments, but encompass various changes, equivalents, or substitutions.

Like reference numerals may be used for like or related elements throughout the drawings. The singular form of a noun corresponding to an item may include one or more items unless the context states otherwise.

Throughout the specification, “A or B”, “at least one of A and B”, “at least one of A or B”, “A, B or C”, “at least one of A, B and C”, and “at least one of A, B, or C” may each include any one or all the possible combinations of A, B and C.

The expression “and/or” is interpreted to include a combination or any of associated elements.

Terms like “first”, “second”, etc., may be simply used to distinguish an element from another, without limiting the elements in a certain sense (e.g., in terms of importance or order).

When an element is mentioned as being “coupled” or “connected” to another element with or without an adverb “functionally” or “operatively”, it means that the element may be connected to the other element directly (e.g., wiredly), wirelessly, or through a third element.

It will be further understood that the terms “comprise” and/or “comprising,” when used in this specification, specify the presence of stated features, integers, steps, operations, elements, parts or combinations thereof, but do not preclude the possible presence or addition of one or more other features, integers, steps, operations, elements, components, and/or groups thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

It is to be understood that blocks of each flowchart and combinations of flowcharts may be performed by one or more computer programs including computer-executable instructions. The one or more computer programs may be stored all in a single memory or may be distributed in many different memories.

An embodiment of the disclosure may be described in terms of functional block elements and various processing operations. Some or all of the functional blocks may be implemented by any number of hardware and/or software components configured to perform the specified functions. For example, the functional blocks may be implemented by one or more microprocessors or circuit elements having dedicated functions. Furthermore, for example, the functional blocks may be implemented in various programing or scripting languages. The functional blocks may be implemented in algorithms executed on one or more processors. Moreover, the disclosure may employ any number of traditional techniques for electronic configuration, signal processing and/or data processing.

Functions or operations related to artificial intelligence (AI) related functions according to the disclosure are operated through a processor and a memory. The processor may be provided in the plural. The single processor or the combination of processors are circuitries for performing processing, which may include an application processor (AP), a communication processor (CP), a graphical processing unit (GPU), a neural processing unit (NPU), a microprocessor unit (MPU), a system on chip (SoC), an integrated chip (IC), etc.

The present disclosure will now be described with reference to accompanying drawings.

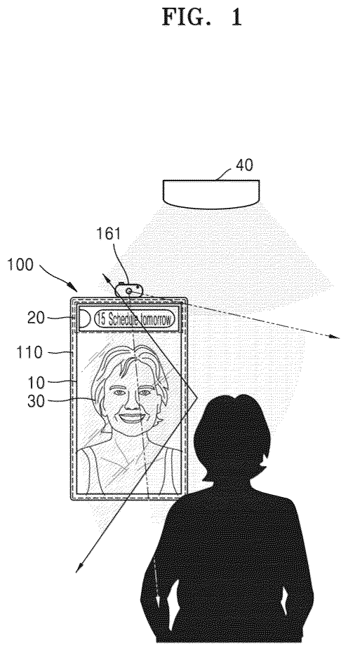

FIG. 1 is a reference diagram illustrating an example of an electronic device for controlling a mirror display, according to an embodiment of the disclosure.

The electronic device 100 may display content. The electronic device 100 may display the content in a content region 20. For example, the electronic device 100 may display content stored in the electronic device 100 or content received from an external electronic device or server in the content region 20. For example, the content region 20 may include an application screen, schedule information, weather information, time information, menus, photos, images, games, educational contents, etc.

The electronic device 100 may reflect light. The electronic device 100 may perform a function of showing an object located in front of the electronic device 100 by reflecting light like a mirror. The electronic device 100 may perform a function of forming an image 30 of the user in front of the electronic device 100 by projecting the user onto a display region 10.

The electronic device 100 may display content in the content region 20 through a mirror display 110. The electronic device 100 may display, in the display region 10 through the mirror display 110, a person located in front of the electronic device 100 in a space where the electronic device 100 is located.

The mirror display 110 may be a display in a form that is coupled with a highly mirror surface, such as a mirror, to provide both normal mirror and display functions. For example, the mirror display 110 may reflect external light like a normal mirror, and may switch over to a display mode to display information. For example, when the brightness of the mirror display 110 is high, the mirror display 110 may switch to a display mode to display information, and when the brightness of the mirror display 110 is low, the mirror display 110 may reflect external light like a normal mirror.

In an embodiment of the disclosure, the electronic device 100 may display content in the display region 10 on the mirror display, or display an object located in front of the electronic device 100 in the display region 10 on the mirror display.

In an embodiment of the disclosure, the display region 10 on the mirror display may refer to a full screen of the mirror display. In an embodiment of the disclosure, the display region 10 on the mirror display may refer to a physical space or physical area among the full screen of the mirror display, which may display content and may also be used as a mirror.

In an embodiment of the disclosure, all or part of the display region 10 on the mirror display may perform the display function to output content obtained from inside or outside of the electronic device 100. All or part of the display region 10 on the mirror display may be used as a mirror to reflect an object in front of the electronic device 100.

In an embodiment of the disclosure, the display region 10 on the mirror display may be an area in which both the mirror function and the display function may be performed. For example, the display region 10 on the mirror display may be used as a mirror while the electronic device 100 displays no content and may be used as a display for displaying content.

In an embodiment of the disclosure, the display region 10 on the mirror display may have different roles depending on the reflectivity of the mirror display 110. For example, when the mirror display 110 (or area) has high reflectivity, it may be used as a mirror, or when the mirror display 110 (or area) has low reflectivity, it may be used as a display.

As such, the display region 10 on the mirror display may be designed to provide a mirror or display function flexibly depending on the situation, thereby enriching the user's experience.

In an embodiment of the disclosure, the electronic device 100 may identify a portion occupied by the content region displayed in the display region 10 on the mirror display.

In an embodiment of the disclosure, the content region 20 may be a region of the display region 10 on the mirror display, in which the electronic device 100 displays content. The display region 10 on the mirror display may include the content region 20. For example, all or part of the display region 10 on the mirror display may be the content region 20.

In an embodiment of the disclosure, the size or position of the content region 20 may be dynamically changed. For example, depending on the type or size of the content, the content region 20 may be the whole or part of the display region 10 on the mirror display.

For example, when the electronic device 100 executes a clock application and a weather application to display time and weather information on the electronic device 100, the content region 20 may be where the time and weather information is displayed.

In an embodiment of the disclosure, the electronic device 100 may control the mirror display 110 to control brightness of the display region 10 on the mirror display based on a proportion occupied by the content region 20 in the display region 10 on the mirror display.

In an embodiment of the disclosure, the electronic device 100 may control the mirror display 110 to make the brightness of the display region 10 on the mirror display be equal to or larger than a reference brightness based on the proportion occupied by the content region 20 in the display region 10 on the mirror display being equal to or larger than a threshold proportion.

For example, when the proportion occupied by the content region 20 in the display region 10 on the mirror display is equal to or larger than the threshold proportion, the electronic device 100 may determine that a function of displaying information rather than reflecting is primarily performed. In order to smoothly perform the information display function by increasing information readability, the electronic device 100 may control the mirror display 110 to make the brightness of the display region 10 on the mirror display be equal to or larger than the reference brightness. Accordingly, the electronic device 100 may smoothly perform the information display function.

In an embodiment of the disclosure, when the proportion occupied by the content region 20 in the display region 10 on the mirror display is less than the threshold proportion, the electronic device 100 may determine that an object reflection function is primarily performed rather than information display. In order to smoothly perform the mirror function, the electronic device 100 may control the mirror display 110 to make the brightness of the display region 10 on the mirror display be less than the reference brightness. Accordingly, the electronic device 100 may smoothly perform the mirror function.

As such, the mirror display 110 may optimize the user's experience by flexibly controlling the brightness depending on weights related to the content and the mirror function.

The electronic device 100 may include a camera 161. The camera 161 may obtain an image of a space where the electronic device 100 is located. The space where the electronic device 100 is located may refer to an indoor space where the electronic device 100 may be installed. The space where the electronic device 100 is located may correspond to various types of indoor spaces such as a house, an office, a store, a guest room, a commercial space, a working space, etc. For example, the camera 161 may obtain an image of an object located in front of the electronic device 100.

The electronic device 100 may identify a person area projected onto the mirror display 110 based on the obtained image, where the person area is an area of the mirror display corresponding to the reflection of a person, and where the reflection of the person corresponds to an image of the person included in the obtained image. For example, an angle of view of the image obtained by the camera 161 may be different from an angle of the object reflecting from the mirror display 110. The electronic device 100 may obtain an image projected onto the mirror display 110 by performing perspective transformation on the obtained image. The electronic device 100 may identify a person area in the image projected onto the mirror display 110 to identify an area occupied by a person among various objects reflected from the electronic device 100.

On the mirror display 110, brightness of an area other than the person area may be set differently from the brightness of the person area. The electronic device 100 may set the brightness of each point in the area of the mirror display other than the person area to be gradually changed from the brightness of the person area as the points grow more distant from the person area. Put another way, the electronic device 100 may set the brightness of each point of the area of the mirror display other than the person area such that the brightness of each point of the area of the mirror display other than the person area changes along a gradient moving away from the person area. For example, the electronic device 100 may determine to reduce the brightness for each point in the area other than the person area as the points grow more distant from the person area.

The electronic device 100 may include an ambient light sensor. The ambient light sensor may detect an illumination level of the space in which the electronic device 100 is located. The electronic device 100 may use a sensor value of the ambient light sensor to identify or obtain the ambient light value. The ambient light value may vary depending on turning-on/off, set ambient light level, lighting, etc., of an indoor lighting device 40 in the space where the electronic device 100 is located.

The electronic device 100 may control the brightness of the display region 10 on the mirror display based on the sensor value obtained by the ambient light sensor. For example, the electronic device 100 may control the brightness of the display region 10 on the mirror display to be reduced, when the sensor value obtained by the ambient light sensor is equal to or greater than a threshold ambient light level. For example, the electronic device 100 may control the brightness of the display region 10 on the mirror display to be increased when the sensor value obtained by the ambient light sensor is less than the threshold ambient light level.

In an embodiment of the disclosure, the electronic device 100 may improve the user's experience by adaptively controlling the brightness of the display region on the mirror display. In an embodiment of the disclosure, the electronic device 100 may adaptively control the brightness of the display region on the mirror display based on the proportion of the content region displayed on the electronic device 100 that plays content.

With this, in a case of using the electronic device 100 primarily for the information display function, the electronic device 100 may increase a sense of immersion of the user by providing a visual environment optimized for viewing the content. In a case of using the electronic device 100 primarily for the mirror function, the electronic device 100 may increase the user's convenience by controlling object reflection to be easily made.

In an embodiment of the disclosure, the electronic device 100 may improve the user's experience by adaptively controlling the brightness of the display region on the mirror display based on the person area projected onto the mirror display so that the person area is mingled in harmony with the other display region. In an embodiment of the disclosure, the electronic device 100 may improve the user's experience by adaptively controlling the brightness of the display region on the mirror display based on the ambient illumination level to provide optimal visibility that fits the environment.

As such, in an embodiment of the disclosure, the electronic device 100 may maximize the user's convenience by flexibly switching roles between the display and the mirror in various environments.

A method by which the electronic device 100 controls the mirror display to control the brightness of the display region on the mirror display according to an embodiment of the disclosure will now be described in detail.

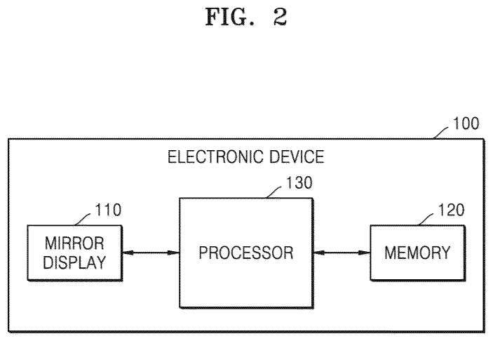

FIG. 2 is a block diagram illustrating a configuration of an electronic device, according to an embodiment of the disclosure.

In an embodiment of the disclosure, the electronic device 100 is a device capable of displaying images or data at the user's request, and may include the mirror display 110, a memory 120 and a processor 130.

The electronic device 100 may be implemented in various forms. The electronic device 100 may be any type of device that includes a processor and a memory to perform a function. The electronic device 100 may be a stationary or portable device. For example, the electronic device 100 may refer to a device equipped with a display to display image content, video content, game content, graphic content, etc. The electronic device 100 may include, for example, a television (TV) such as a network TV, a smart TV, an Internet TV, a web TV, an Internet protocol (IP) TV or the like, a computer such as a desktop, a laptop, a tablet or the like, or various types of electronic devices capable of receiving and outputting content such as various smart devices, e.g., a smart phone, a cellular phone, a game player, a music player, a video player, medical equipment, a home appliance product, etc. The electronic device 100 may be referred to as a display device in terms of displaying content, or also referred to as a content providing device, a computing device, etc.

The mirror display 110 may be a display that is able to provide mirror and display functions. A mirror display 110 is a type of display device that functions both as a mirror and as a digital screen.

The mirror display 110 may refer to an electronic device in which information display and mirror functions are combined. The mirror display 110 may be called other various terms. For example, the mirror display 110 may refer to a smart mirror, micro light emitting diodes (LEDs), an LED mirror with pixel-level light adjustment, a mirror screen, a smart mirror, a mirror-effect display, a mirror display or a projection display.

The mirror display 110 may reflect external light like a normal mirror, and switch over to a display to display information as needed. The mirror display 110 may reduce the effect of reflection of ambient light or reinforce the mirror function of the display by adjusting brightness or reflectivity. The mirror display 110 may be properly used in various use environments by adjusting brightness or reflectivity.

The mirror display 110 may indirectly control the reflectivity by controlling brightness. For example, when the brightness of the mirror display 110 is increased, light emission of the mirror display 110 becomes intense, thereby reducing reflections and thus lowering the reflectivity. For example, when the brightness of the mirror display 110 is reduced, light emission of the mirror display 110 becomes lower, thereby increasing reflections and thus increasing the reflectivity.

In an embodiment of the disclosure, the mirror display 110 may provide at least one of a reflecting function or a display function. The mirror display 110 may differently set the brightness or reflectivity for each section. For example, the mirror display 110 may set the brightness of a first section on the mirror display 110 to first brightness and the brightness of a second section to second brightness.

In an embodiment of the disclosure, the mirror display 110 may include a structure in which a mirror for reflecting function is coupled with a display panel for display function. This combined structure may provide a function for the user to check information displayed on the display panel and his/her reflection through the mirror simultaneously.

The memory 120 may store a program for processing and control of the processor 130, and store data input to or output from the electronic device 100. Furthermore, the memory 120 may store data required for operation of the electronic device 100.

The memory 120 may include at least one type of storage medium including a flash memory, a hard disk, a multimedia card micro type memory, a card type memory (e.g., secure digital (SD) or extreme digital (XD) memory), a random access memory (RAM), a static RAM (SRAM), a read only memory (ROM), an electrically erasable programmable ROM (EEPROM), a programmable ROM (PROM), a magnetic memory, a magnetic disk, and an optical disk.

The memory 120 may not be separately present but integrated into the processor 130. The memory 120 may include a volatile memory, a non-volatile memory, or a combination of the volatile memory and the non-volatile memory. The memory 120 may store a program or at least one instruction for performing operations according to the following embodiments of the disclosure. The memory 120 may also provide the stored data to the processor 130 at the request of the processor 130.

The processor 130 controls general operation of the electronic device 100. The processor 130 may be configured with one or more processors to control a series of processes for operating the electronic device 100 according to embodiments as will be described below. One or more processors included in the processor 130 may be such circuitries as system on chips (SoCs), integrated circuits (ICs), etc. One or more processors included in the processor 130 may be a universal processor such as a CPU, an MPU, an AP, a DSP, etc., a dedicated graphic processor such as a GPU, a VPU, etc., a dedicated AI processor such as an NPU or a dedicated communication processor such as a CP. When the one or more processors included in the processor 130 are the dedicated AI processors, the dedicated AI processors may be designed in a hardware structure that is specific to dealing with a particular AI model.

The processor 130 may record data in the memory 120 or read out data stored in the memory 120, and especially, execute the program or the at least one instruction stored in the memory 120 to process data according to a predefined operation rule or AI model. The processor 130 may perform operations as will be described in the following embodiments, and the operations described as being performed by the electronic device 100 in the following embodiments may be regarded as being performed by the processor 130 unless stated otherwise.

For example, the processor 130 may perform a function of the electronic device 100 as described in the disclosure by executing one or more instructions stored in the memory 120 individually or collectively. In other words, in an embodiment of the disclosure, the at least one instruction stored in the memory 120 may be executed by the processor 130 individually or collectively for the electronic device 100 to perform functions as described in the disclosure.

In an embodiment of the disclosure, the processor 130 may execute the at least one instruction stored in the memory 120 individually or collectively to identify a proportion occupied by the content region displayed in the display region on the mirror display.

In an embodiment of the disclosure, the processor 130 may execute the at least one instruction stored in the memory 120 individually or collectively to control the mirror display to control brightness of the display region on the mirror display based on the proportion occupied by the content region in the display region.

In an embodiment of the disclosure, the processor 130 may execute the at least one instruction stored in the memory 120 individually or collectively to control the mirror display so that the brightness of the display region on the mirror display is equal to or larger than a reference brightness based on the proportion occupied by the content region in the display region being equal to or larger than a threshold proportion.

In an embodiment of the disclosure, the processor 130 may execute the at least one instruction stored in the memory 120 individually or collectively to control the mirror display so that the brightness of the display region is less than the reference brightness based on the proportion occupied by the content region in the display region being less than the threshold proportion.

In an embodiment of the disclosure, the processor 130 may execute the at least one instruction stored in the memory 120 individually or collectively to obtain an image through a camera.

In an embodiment of the disclosure, the processor 130 may execute the at least one instruction stored in the memory 120 individually or collectively to identify a person area projected onto the mirror display based on the obtained image.

In an embodiment of the disclosure, the processor 130 may execute the at least one instruction stored in the memory 120 individually or collectively to set brightness of an area other than the person area on the mirror display differently from the brightness of the person area.

In an embodiment of the disclosure, the processor 130 may execute the at least one instruction stored in the memory 120 individually or collectively to set brightness of each point in the area other than the person area to gradually change from the brightness of the person area as the point grows distant from the person area.

In an embodiment of the disclosure, the processor 130 may execute the at least one instruction stored in the memory 120 individually or collectively to control the brightness of the display region on the mirror display based on a sensor value obtained by an ambient light sensor.

In an embodiment of the disclosure, the processor 130 may execute the at least one instruction stored in the memory 120 individually or collectively to control the brightness of the display region on the mirror display to be reduced when the sensor value obtained by the ambient light sensor is equal to or greater than a threshold ambient light level.

In an embodiment of the disclosure, the processor 130 may execute the at least one instruction stored in the memory 120 individually or collectively to control the brightness of the display region on the mirror display to be increased when the sensor value obtained by the ambient light sensor is less than the threshold ambient light level.

In an embodiment of the disclosure, the processor 130 may execute the at least one instruction stored in the memory 120 individually or collectively to identify an object in the content.

In an embodiment of the disclosure, the processor 130 may execute the at least one instruction stored in the memory 120 individually or collectively to obtain a content region by inpainting a surrounding area of the identified object.

In an embodiment of the disclosure, the processor 130 may execute the at least one instruction stored in the memory 120 individually or collectively to set brightness of an area other than the content region on the mirror display differently from the brightness of the content region.

In an embodiment of the disclosure, the processor 130 may execute the at least one instruction stored in the memory 120 individually or collectively to set brightness of each point in the area other than the content region to gradually change from the brightness of the content region as the point grows distant from the content region.

In an embodiment of the disclosure, the processor 130 may execute the at least one instruction stored in the memory 120 individually or collectively to obtain a projection image projected onto the mirror display from the image obtained by the camera. In an embodiment of the disclosure, the processor 130 may execute the at least one instruction stored in the memory 120 individually or collectively to identify the person area in the projection image.

In an embodiment of the disclosure, the processor 130 may execute the at least one instruction stored in the memory 120 individually or collectively to obtain a user input to select a screen mode in which brightness of the display region is set to be equal to or larger than the reference brightness or a mirror mode in which the brightness of the display region is set to be less than the reference brightness.

In an embodiment of the disclosure, the processor 130 may execute the at least one instruction stored in the memory 120 individually or collectively to switch into the screen mode or the mirror mode based on the user input.

In an embodiment of the disclosure, the processor 130 may execute the at least one instruction stored in the memory 120 individually or collectively to determine whether a person is identified in the image obtained through the camera.

In an embodiment of the disclosure, the processor 130 may execute the at least one instruction stored in the memory 120 individually or collectively to switch into the mirror mode based on determining that the person is identified.

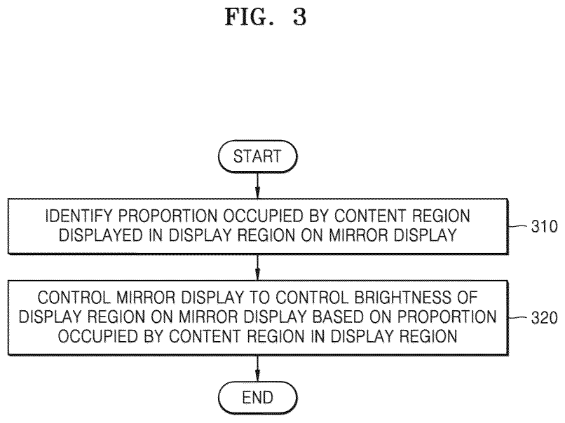

FIG. 3 is a flowchart illustrating a method of controlling a mirror display, according to an embodiment of the disclosure.

In operation 310, the electronic device 100 may identify a proportion occupied by a content region displayed in a display region on the mirror display.

For example, the electronic device 100 may identify the display region on the mirror display in pixels. The electronic device 100 may calculate the proportion occupied by the content region in the display region by computing (or, determining) the number of pixels of content displayed in the display region on the mirror display. For example, when a total number of pixels included in the display region on the mirror display is 1,000, and the content is displayed in 400 pixels, the content proportion occupied by the content region in the display region is 40%.

For example, the electronic device 100 may divide the display region on the mirror display and analyze (or identify) a portion where the content is displayed in each divided section. The electronic device 100 may determine the content proportion occupied by the content region in the display region by comparing an area of the portion where the content is displayed with the whole display region.

In an embodiment of the disclosure, the electronic device 100 may dynamically update (e.g. identify or determine) the proportion occupied by the content region in the display region when the area occupied by the content region in the display region on the mirror display is changed. In an embodiment of the disclosure, when the area occupied by the content region in the display region on the mirror display is changed, the electronic device 100 may update (e.g., compute, determine, identify or determine) the content proportion occupied by the content region in the display region in real time.

In operation 320, the electronic device 100 may control the mirror display to control the brightness of the display region on the mirror display. In an embodiment of the disclosure, the electronic device 100 may control the mirror display to control (e.g., determine) the brightness of the display area on the mirror display based on the proportion occupied by the content region in the display region on the mirror display.

In an embodiment of the disclosure, the electronic device 100 may detect the proportion occupied by the content region in the display region in real time to dynamically control (e.g., determine) the brightness of the display region on the mirror display. The electronic device 100 may provide customized brightness control that fits the user's need and the purpose of use of the electronic device 100 by controlling the brightness of the display region on the mirror display.

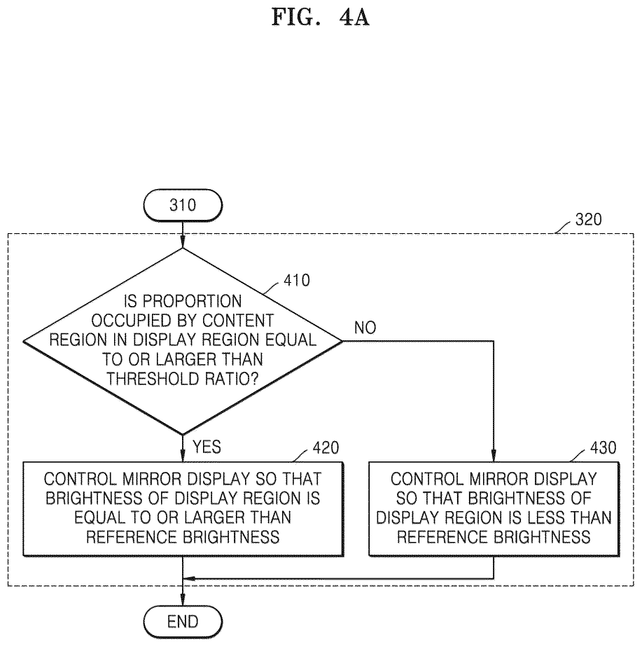

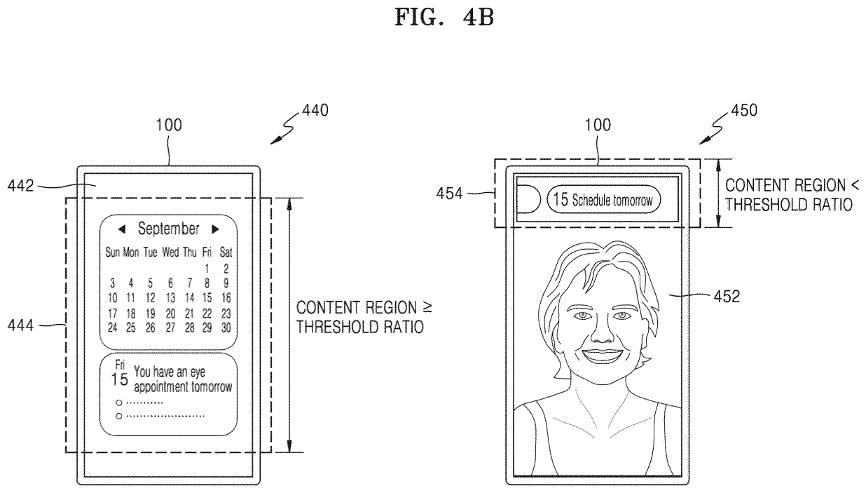

FIG. 4A is a flowchart for describing details of operation 320 of FIG. 3 to control brightness of a display region on a mirror display based on a proportion occupied by a content region in the display region, according to an embodiment of the disclosure.

In operation 410, the electronic device 100 may identify whether a proportion occupied by the content region in the display region is equal to or larger than a threshold proportion.

In an embodiment of the disclosure, the electronic device 100 may determine whether a proportion occupied by a content region 20 in the display region 10 identified in operation 310 is equal to or larger than the threshold proportion.

The threshold proportion may be a basis to distinguish whether the electronic device 100 primarily performs the information display function or the mirror function. For example, in a case that the threshold proportion is 50%, when the content region occupies more than half the display region on the mirror display, it may be determined that the information display function is prioritized. The threshold proportion may be a preset value, a value set by the user, or a value changing in real time.

In operation 420, the electronic device 100 may control the mirror display so that the brightness of the display region on the mirror display is equal to or larger than a reference brightness. In an embodiment of the disclosure, the electronic device 100 may control the mirror display to make the brightness of the display region on the mirror display be equal to or larger than the reference brightness based on the proportion occupied by the content region in the display region being equal to or larger than the threshold proportion.

In an embodiment of the disclosure, the electronic device 100 may determine that the information display function is prioritized over the mirror function in the electronic device 100 based on the proportion occupied by the content region in the display region being equal to or larger than the threshold proportion. The electronic device 100 may determine that brightness control is required to reduce reflectivity of the mirror display 110 and increase content visibility.

In an embodiment of the disclosure, the electronic device 100 may control the brightness of the display region on the mirror display in pixels. In an embodiment of the disclosure, the electronic device 100 may control the brightness of the display to be the reference brightness or higher by minutely controlling the light emission level of each pixel included in the display region on the mirror display. The electronic device 100 may increase the brightness of the pixel in the display region on the mirror display. The electronic device 100 may increase the brightness of a backlight unit corresponding to each pixel in the display region on the mirror display 110, e.g., the brightness of an LED light source, thereby reducing overall reflectivity of the screen to increase information readability. For example, the electronic device 100 may set the pixel brightness in the display region on the mirror display to 100%.

In an embodiment of the disclosure, the electronic device 100 may increase brightness of only particular pixels in the display region on the mirror display 110. In an embodiment of the disclosure, the electronic device 100 may collectively control the brightness of all the pixels in the display region on the mirror display 110 to make required content seen clearly.

In an embodiment of the disclosure, even when the electronic device 100 controls the mirror display 110 to make the brightness of the display region 10 on the mirror display be the reference brightness or higher, the mirror display 110 may also perform the mirror function as well. For example, the electronic device 100 may control the mirror display 110 to show the content clearly and also show the partial reflection of the user who is located in front of the electronic device 100.

In operation 430, the electronic device 100 may control the mirror display so that the brightness of the display region on the mirror display is less than the reference brightness. In an embodiment of the disclosure, the electronic device 100 may control the mirror display to make the brightness of the display region on the mirror display be lower than the reference brightness based on the proportion occupied by the content region in the display region being less than the threshold proportion.

In an embodiment of the disclosure, the electronic device 100 may determine that the mirror function is prioritized over the information display function in the electronic device 100 based on the proportion occupied by the content region in the display region being less than the threshold proportion. The electronic device 100 may determine that brightness control is required to increase reflectivity of the mirror display 110.

In an embodiment of the disclosure, the electronic device 100 may control (e.g., determine) the brightness of the display region on the mirror display in pixels. In an embodiment of the disclosure, the electronic device 100 may control (e.g., determine) the brightness of the display to be less than the reference brightness by minutely controlling the light emission level of each pixel included in the display region on the mirror display. The electronic device 100 may reduce the brightness of the pixel in the display region on the mirror display. The electronic device 100 may reduce the brightness of an individual LED light source of each pixel in the display region on the mirror display 110, thereby increasing overall reflectivity of the screen to increase the mirror reflecting function. For example, the electronic device 100 may set (e.g., determine) the pixel brightness in the display region on the mirror display to 0%.

In an embodiment of the disclosure, the electronic device 100 may reduce brightness of only particular pixels in the display region on the mirror display 110. In an embodiment of the disclosure, the electronic device 100 may collectively control (e.g., determine, change) the brightness of all the pixels in the display region on the mirror display 110 to make the reflected object seen naturally.

In an embodiment of the disclosure, even when the electronic device 100 controls the mirror display 110 to make the brightness of the display region 10 on the mirror display be less than the reference brightness, the mirror display 110 may also perform the information display function as well. For example, the electronic device 100 may perform the mirror function to reflect the feature of the user located in front of the electronic device 100 off the electronic device 100, but may control the mirror display 110 to display both the content displayed on the electronic device 100 and the feature of the user.

FIG. 4B is a reference diagram for describing an example of controlling brightness of a display region on a mirror display based on a proportion occupied by a content region in the display region, according to an embodiment of the disclosure.

In a first example 440, the electronic device 100 may identify a proportion occupied by a content region 444 in a display region 442 on the mirror display. In the first example 440, calendar and schedule applications are displayed on the majority of the display region 442 on the mirror display. The electronic device 100 may determine that the proportion occupied by the content region 444 in the display region 442 on the mirror display is equal to or larger than a threshold proportion.

In the first example 440, the electronic device 100 may control the mirror display to make the brightness of the display region on the mirror display be equal to or larger than the reference brightness based on the proportion occupied by the content region in the display region being equal to or larger than the threshold proportion. In an embodiment of the disclosure, the electronic device 100 may control the mirror display to make the brightness of the display region on the mirror display be equal to or larger than the reference brightness to increase readability of the calendar and schedule application in the content region 444.

In the first example 440, the electronic device 100 may also control the mirror display to reflect and display the reflection of the user located in front of the electronic device 100 on the electronic device 100 while increasing the readability of the calendar and schedule application.

In a second example 450, the electronic device 100 may identify a proportion occupied by a content region 454 in a display region 452 on the mirror display. In the second example 450, a schedule application is displayed only in an upper portion of the display region 452 on the mirror display. The electronic device 100 may determine that a proportion occupied by the content region 454 in the display region 452 on the mirror display is less than a threshold proportion.

In the second example 450, the electronic device 100 may control the mirror display to make the brightness of the display region on the mirror display be less than the reference brightness based on the proportion occupied by the content region in the display region being less than the threshold proportion. In an embodiment of the disclosure, the electronic device 100 may control the mirror display to make the brightness of the display region on the mirror display be less than the reference brightness to increase readability of the calendar and schedule application in the content region 454.

In the second example 450, the electronic device 100 may also display information such as the calendar and schedule application while controlling the mirror display to display the reflection of the user located in front of the electronic device 100 on the electronic device 100.

For example, the electronic device 100 may display the reflection of the user located in front of the electronic device 100 on the electronic device 100, in which case content in a region where the feature of the user is displayed may be blurredly displayed. For example, the electronic device 100 may display the reflection of the user located in front of the electronic device 100 on the electronic device 100, in which case content in the content region 454 where the feature of the user is not displayed may be clearly displayed by increasing pixel brightness in the content region 454.

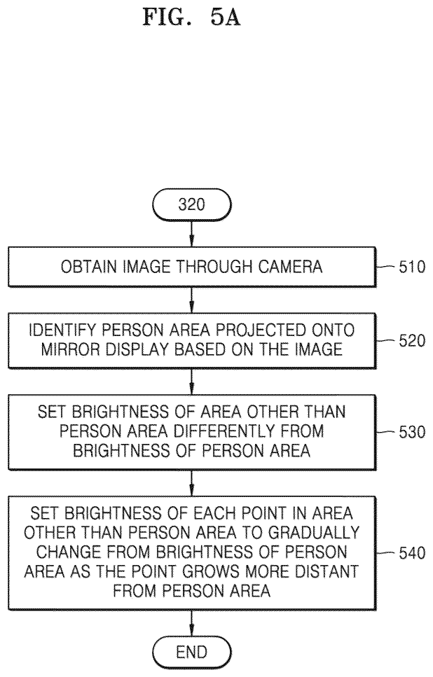

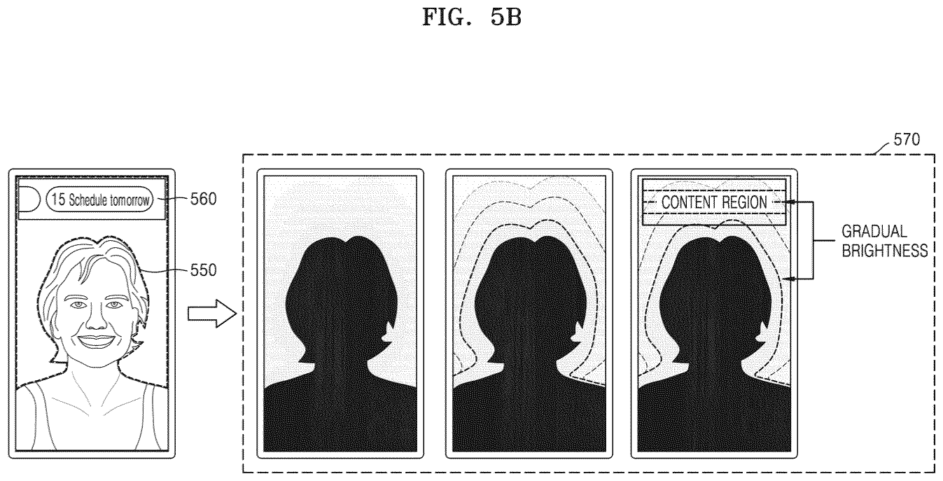

FIG. 5A is a flowchart illustrating a method of controlling brightness of a person area on a mirror display or an area other than the person area, according to an embodiment of the disclosure.

In operation 510, the electronic device 100 may obtain an image through a camera. In an embodiment of the disclosure, the camera may refer to an image sensor having an image acquisition function. In an embodiment of the disclosure, the electronic device 100 may include the camera. For example, the camera may be installed in the top center of the electronic device 100, but the disclosure is not limited to the aforementioned embodiment.

In operation 520, the electronic device 100 may identify a person area projected onto the mirror display based on the obtained image. An angle of the image obtained by the electronic device 100 through the camera may be different from an angle of an object reflected off the mirror display. The electronic device 100 may identify the person area projected onto the mirror display by performing perspective transformation on the obtained image.

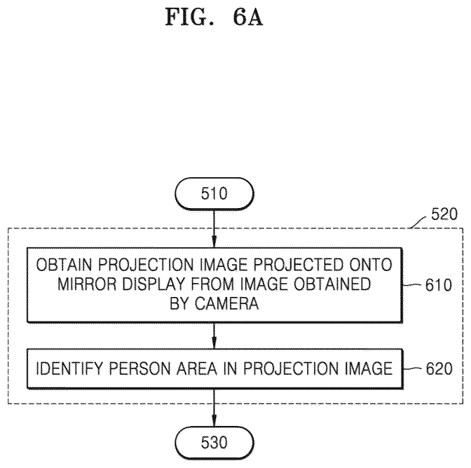

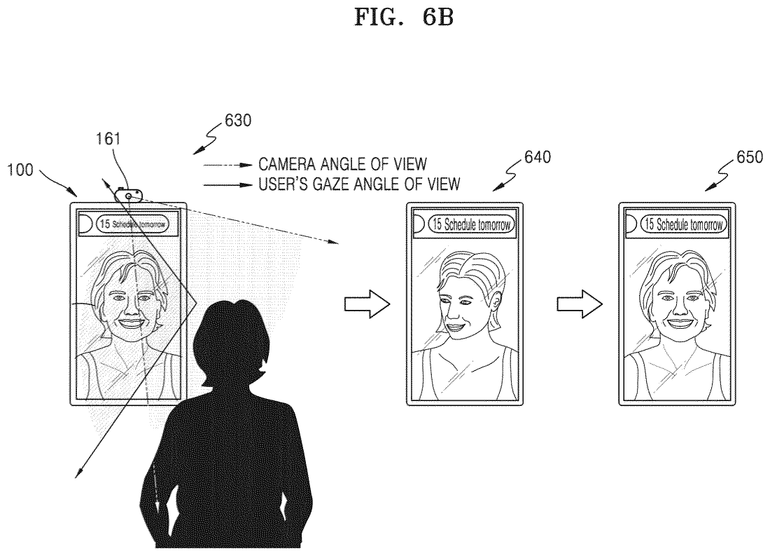

FIG. 6A is a flowchart for describing details of operation 520 of FIG. 5A to identify a person area projected onto the mirror display, according to an embodiment of the disclosure.

In operation 610, the electronic device 100 may obtain a projection image projected in the display region on the mirror display from the image obtained by the camera. In an embodiment of the disclosure, the electronic device 100 may obtain the projection image by performing the perspective transformation on the image obtained by the camera. The obtaining of the projection image projected in the display region from the image obtained by the camera may include predicting the projection image from the image obtained by the camera or obtaining an image as close to the projection image as possible from the image obtained by the camera.

In an embodiment of the disclosure, a viewpoint (or angle) at which the camera obtains the image may be different from a viewpoint (or angle) of the image displayed on the display of the electronic device 100. For example, when the camera is located in the top center on the front of the electronic device 100, the camera may capture an image in a direction from top to bottom.

In an embodiment of the disclosure, the image captured by the camera may be an image of an object to be projected onto the mirror display viewed from a relatively high angle. The object projected onto the mirror display may be located right in front of the mirror display such as a normal mirror.

The electronic device 100 may correct a difference between the viewpoint of the camera and the viewpoint displayed on the mirror display. For example, the electronic device 100 may compute the location of the camera, the location of the mirror display and the difference in viewpoint. The electronic device 100 may transform the viewpoint of the captured image to be close to the front viewpoint to generate the projection image by applying a three-dimensional (3D) perspective transformation algorithm. For example, the electronic device 100 may transform the viewpoint of the captured image to be close to the front viewpoint to generate the projection image by applying a homography algorithm.

In an embodiment of the disclosure, the electronic device 100 may use an AI algorithm to learn changes in image formed on the mirror display for each position of the camera. The electronic device 100 may include an AI algorithm that learns the changes in image formed on the mirror display for each position of the camera in advance.

In operation 620, the electronic device 100 may identify a person area in the projection image. The person area may be an area that represents the size and position of a person. The position and range of the person area may be identified differently depending on the size and position of the recognized person.

The electronic device 100 may identify the person area on the mirror display based on the image obtained by the camera. For example, the electronic device 100 may identify the person area by using an AI algorithm.

For example, the electronic device 100 may recognize a person in the projection image by using an object detection algorithm or a person recognition algorithm. The electronic device 100 may identify the person area based on a bounding box around the recognized person based on the recognized person. For example, the electronic device 100 may identify the person area by extracting an accurate outline of the person.

FIG. 6B is a reference diagram for describing an example of operation 610 of FIG. 6A for obtaining an image projected onto the mirror display based on an image obtained by a camera, according to an embodiment of the disclosure.

In operation 630, the mirror display of the electronic device 100 may project the user located right in the front. The camera 161 may be located in the top center of the electronic device 100, and thus obtain an image of the user who is located right in front of the mirror display at a relatively high angle

For example, the electronic device 100 may obtain an image 640 through the camera 161.

For example, the electronic device 100 may obtain a projection image 650 projected onto the mirror display by performing perspective transformation on the obtained image 640.

Turning back to FIG. 5A, in operation 530, the electronic device 100 may set (e.g., determine) the brightness of an area other than the person area differently from the brightness of the person area.

The electronic device 100 may control (e.g., determine) the brightness of the display region on the mirror display for each section. In an embodiment of the disclosure, the electronic device 100 may set (e.g., determine) the brightness of the area other than the person area to be higher than the person area. In an embodiment of the disclosure, the electronic device 100 may control (e.g., determine) the brightness of the display region on the mirror display for each pixel. The electronic device 100 may set (e.g., determine) the pixel brightness corresponding to the person area in the display region on the mirror display to be lower than the pixel brightness corresponding to the area other than the person area.

In an embodiment of the disclosure, the electronic device 100 may determine for the electronic device 100 to perform the mirror function in an area in which the person is projected, by setting the brightness of the person area to be relatively low. In an embodiment of the disclosure, the electronic device 100 may determine for the electronic device 100 to perform the information display function in an area in which no person is projected, by setting (e.g., determining) the brightness of the area other than the person area to be relatively high.

In operation 540, the electronic device 100 may set (e.g., determine) the brightness of the area other than the person area on the mirror display to be gradually changed based on the distance of the area other than the person area from the person area. The electronic device 100 may set (e.g., determine) the brightness value such that the brightness of the area other than the person area on the mirror display is gradually changed from the brightness of the person area as the area other than the person area grows distant from the person area.

In an embodiment of the disclosure, the electronic device 100 may set the brightness of the person area to first brightness. The electronic device 100 may set the brightness of a pixel corresponding to the person area to first brightness. The electronic device 100 may obtain (or compute) a distance of the area other than the person area to the person area. For example, the electronic device 100 may obtain (or compute) a distance of at least one pixel corresponding to the area other than the person area to the person area. For example, the electronic device 100 may obtain (e.g., identify, compute, or determine) a distance of at least one pixel corresponding to the area other than the person area to the boundary of the person area.

In an embodiment of the disclosure, the electronic device 100 may set (e.g., determine) the brightness of the area other than the person area on the mirror display. In an embodiment of the disclosure, as the area other than the person area grows distant from the person area, the brightness of the area other than the person area may be set (e.g., determined) to gradually change from the brightness of the person area.

For example, the electronic device 100 may classify the area other than the person area according to the distance to the person area, and determine brightness of the classified area individually. For example, the electronic device 100 may compute (e.g., determine) a distance of an area other than the person area to the person area, and set (e.g., determine) the brightness of the area other than the person area to a value that continuously change according to the distance. For example, the electronic device 100 may increase the brightness and reduce the reflectivity as the area other than the person area grows distant from the person area.

For example, when the brightness of the person area is 50%, brightness of an area having a distance to the area other than the person area being equal to or larger than a first distance and less than a second distance may be set to 60%, brightness of an area having a distance to the area other than the person area being equal to or larger than the second distance and less than a third distance may be set to 70%, and brightness of an area having a distance to the area other than the person area being equal to or larger than the third distance and less than a fourth distance may be set to 80%. In this case, the first distance may be larger than the second distance, the second distance may be larger than the third distance, and the third distance may be larger than the fourth distance.

The electronic device 100 may gradually control the brightness of the area other than the person area so that the person area and the area other than the person area are mingled in harmony without giving a sense of being foreign. For example, the electronic device 100 may provide an effect in which the brightness of the area other than the person area fades in or fades out from the brightness of the person area.

FIG. 5B is a reference diagram for describing an example of controlling brightness of a person area on a mirror display or an area other than the person area, according to an embodiment of the disclosure

The electronic device 100 may identify a person area 550 projected onto the mirror display based on the image obtained by the camera. The electronic device 100 may identify a content region 560 displayed on the mirror display.

In operation 570, the electronic device 100 may set (e.g., determine) the brightness of the area other than the person area on the mirror display differently from the brightness of the person area.

For example, the electronic device 100 may attain technical effects of increasing the attention on a person by reducing the brightness of the person area 550 and increasing the reflectivity to make the person projected. The electronic device 100 may increase the user' concentration on the person by relatively increasing the brightness of the content region 560 around and controlling the reflectivity to be reduced.

For example, the electronic device 100 may provide a function of gradually reducing the brightness of the surrounding area other than the person area 550. For example, the electronic device 100 may control the mirror display to gradually increase the brightness and gradually reduce the reflectivity of an area other than the person area.

As the electronic device 100 controls the mirror display to gradually increase the brightness of the area other than the person area, the user may pay more attention to the expression or behavior of the person. With this, the electronic device 100 may provide the user with an immersive experience by making clear a visual difference between the person and the content in a situation such as a video conference or video call.

In addition, the electronic device 100 may provide an improved visual experience in various environments by controlling brightness and color of the person area as needed by the user. This technology may contribute to improving efficiency of video conferencing, live streaming and various multimedia content consumption.

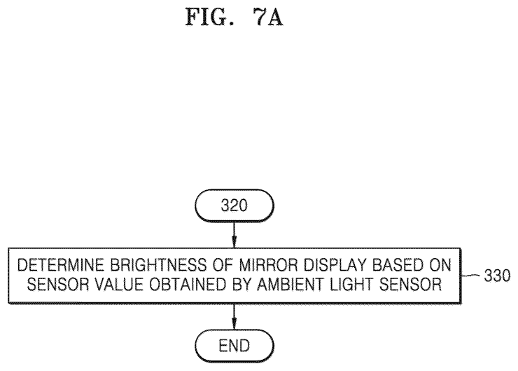

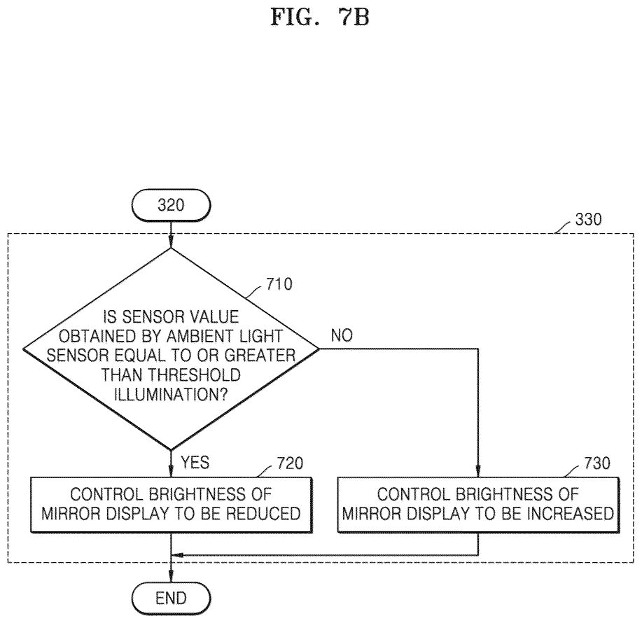

FIG. 7A is a flowchart illustrating a method of controlling brightness of a display region on a mirror display based on a surrounding environment of an electronic device, according to an embodiment of the disclosure.

The electronic device 100 may recognize the surrounding environment of the electronic device 100. The surrounding environment of the electronic device 100 may refer to a physical condition or situation around the electronic device 100. The surrounding environment may include various information relating to the user or an environment when the electronic device 100 displays a content in the display region on the mirror display. For example, the surrounding environment may include at least one of a surrounding illumination level, whether the user is present, or the user's behavior. The electronic device 100 may control the brightness of the display region on the mirror display based on the obtained surrounding environment. In this regard, in an embodiment of the disclosure, a method of controlling brightness of the display region on the mirror display based on the ambient illumination level of the electronic device 100 will now be described.

In operation 330, the electronic device 100 may control (e.g., determine) the brightness of the display region on the mirror display based on a sensor value obtained by an ambient light sensor.

In an embodiment of the disclosure, the electronic device 100 may include the ambient light sensor. The ambient light sensor is a sensor for measuring brightness of a space where the electronic device 100 is located. The ambient light sensor may include, for example, a photoresistor, a photodiode, or a phototransistor. The ambient light sensor may be placed right in front of the electronic device 100 to face the space where the electronic device 100 is located in order to detect the illumination level of the space, but is not limited thereto. The electronic device 100 may generate and send a sensor value to the processor.

FIG. 7B is a flowchart for describing details of operation 330 of FIG. 7A to control brightness of the display region on the mirror display based on the sensor value obtained by the ambient light sensor, according to an embodiment of the disclosure.

In operation 710, the electronic device 100 may identify whether the sensor value obtained by the ambient light sensor is equal to or greater than a threshold illumination level.

In an embodiment of the disclosure, the electronic device 100 may obtain the illumination value with the ambient light sensor. In an embodiment of the disclosure, the electronic device 100 may obtain an illumination value by performing a certain process on the sensor value obtained from the ambient light sensor. The electronic device 100 determines whether the illumination value is equal to or greater than the threshold illumination level. The threshold illumination level may be, for example, about 6 lux.

In operation 720, the electronic device 100 may control the mirror display to reduce the brightness of the display region. In an embodiment of the disclosure, the electronic device 100 may control the brightness of the display region on the mirror display to be reduced, when the sensor value obtained by the ambient light sensor is equal to or greater than the threshold illumination level. The electronic device 100 may increase visibility of the screen and efficiently use the energy in an environment in which the ambient illumination level is high by reducing the brightness of the display region on the mirror display.

For example, when the ambient illumination level of the electronic device 100 is equal to or larger than the threshold illumination level, and the electronic device 100 sets the brightness of the display region on the mirror display to be high, the user of the electronic device 100 may experience glaring. The user of the electronic device 100 may then have eye strain. In this case, the electronic device 100 may generate a comfortable environment for use of the electronic device 100 by reducing the brightness of the display region on the mirror display to increase the contrast between the brightness of the mirror display and the ambient illumination level of the electronic device 100.

In an embodiment of the disclosure, the ambient light sensor of the electronic device 100 may detect (e.g., identify) a change in ambient illumination level. When identifying a change in ambient illumination level to the threshold illumination level or higher, the electronic device 100 may control the brightness of the display region on the mirror display based on the obtained sensor value. The electronic device 100 may determine the brightness of the display region on the mirror display based on the surrounding illumination level. The electronic device 100 may improve user experiences in using the electronic device by controlling the brightness of the display region on the mirror display.

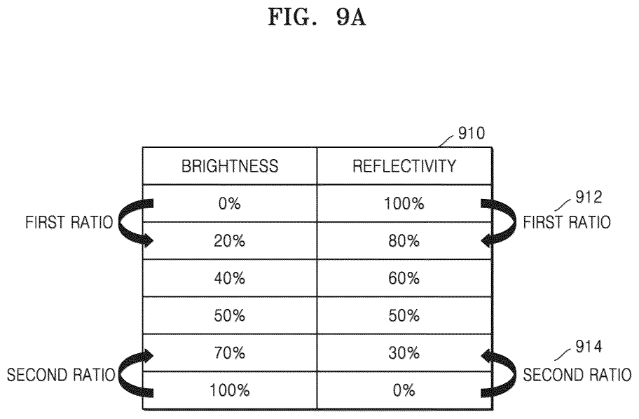

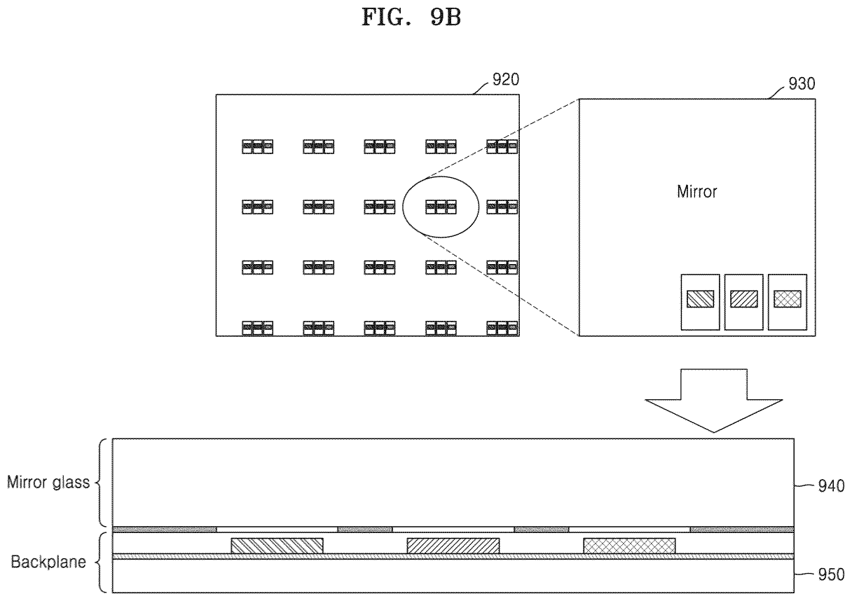

In an embodiment of the disclosure, as the electronic device 100 controls the brightness of the display region on the mirror display to be reduced, the reflectivity of the mirror display may be increased. The relationship between the brightness and reflectivity of the display region on the mirror display will be described with reference to FIGS. 9A and 9B, and for the sake of brevity, overlapping description will not be repeated.

In operation 730, the electronic device 100 may control the mirror display to increase the brightness of the display region. In an embodiment of the disclosure, the electronic device 100 may control the brightness of the display region on the mirror display to be increased, when the sensor value obtained by the ambient light sensor is less than the threshold illumination level. The electronic device 100 may secure readability to help the user easily read text on the electronic device 100 in a low-illuminated (or dark) surrounding environment by increasing the brightness of the display region on the mirror display.

For example, when the ambient illumination level of the electronic device 100 is less than the threshold illumination level, and the electronic device 100 sets the brightness of the display region on the mirror display to be low, the user of the electronic device 100 may have difficulty in recognizing the content displayed on the electronic device 100. For example, when the brightness of the display region on the mirror display is set to be low in the low-illuminated surrounding environment, text or images displayed on the electronic device 100 may be close to the dark background, making the screen content appear blurry or difficult to recognize.

In an embodiment of the disclosure, the ambient light sensor of the electronic device 100 may detect a change in ambient illumination level. When recognizing a change in ambient illumination level to less than the threshold illumination level, the electronic device 100 may control the brightness of the display region on the mirror display based on the obtained sensor value. The electronic device 100 may determine the brightness of the display region on the mirror display based on the ambient illumination level. The electronic device 100 may improve user experiences in using the electronic device by controlling the brightness of the display region on the mirror display.

In an embodiment of the disclosure, as the electronic device 100 controls the brightness of the display region on the mirror display to be increased, the reflectivity of the mirror display may be reduced. The relationship between the brightness and reflectivity of the display region on the mirror display will be described with reference to FIGS. 9A and 9B, and for the sake of brevity, overlapping description will not be repeated.

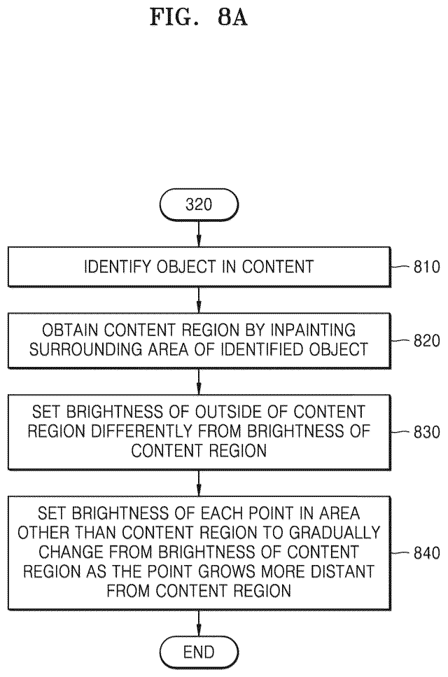

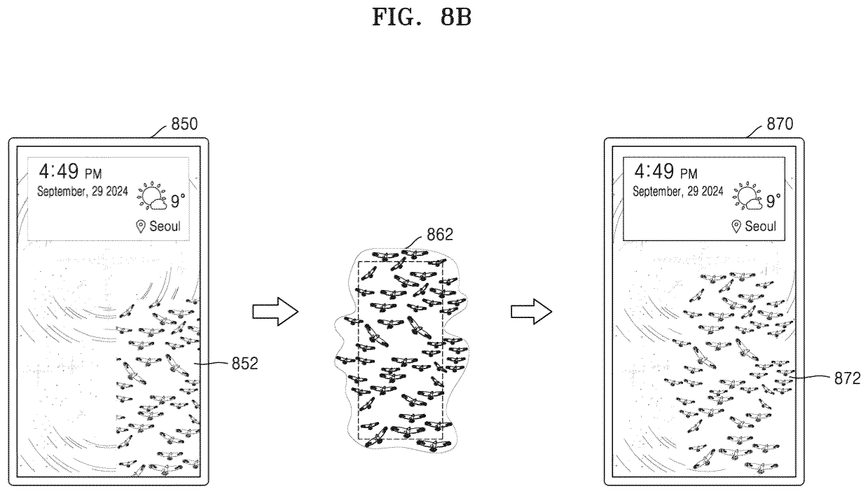

FIG. 8A is a flowchart illustrating a method of controlling brightness of a content region and an area other than the content region, according to an embodiment of the disclosure.

In operation 810, the electronic device 100 may identify an object in content. In an embodiment of the disclosure, the content may refer to an image displayed on the electronic device 100. In an embodiment of the disclosure, the content may refer to an image input to the electronic device 100. The electronic device 100 may identify (or recognize) an object contained in the content. In an embodiment of the disclosure, the object in the content may be an object displayed in a separate screen frame.

In an embodiment of the disclosure, the object may be at least one of a person or a thing. The electronic device 100 may use a computer vision technology (e.g., an object detecting algorithm) to identify the object in the content. The electronic device 100 may extract the position and size of the object in the screen frame. The electronic device 100 may use a machine learning model to analyze a feature of the object, and based on this, distinguish whether the object is a person, an animal or a particular thing.

For example, when the content includes multiple fish, the electronic device 100 may identify each fish, extract the position and size of the identified fish and identify whether there is no cut in the middle from the fish on the screen.

For example, the electronic device 100 may use a face recognition algorithm to recognize a specific person in the content.

In operation 820, the electronic device 100 may obtain the content region by inpainting the area surrounding the identified object. In an embodiment of the disclosure, inpainting may refer to a method of obtaining a natural image by filling in a certain area with a different background or processing the area as if there has not been an object. The electronic device 100 may use an AI based inpainting algorithm. The electronic device 100 may fill in an empty area naturally by inpainting the area surrounding an object identified in the screen frame.

For example, when the content includes multiple fish and some of the fish located near the edges are cut, the electronic device 100 may inpaint the area surrounding the identified fish to obtain a content region that is in harmony with the background area with the fish not cut in the middle.

In operation 830, the electronic device 100 may set the brightness of an area other than the content region on the mirror display differently from the brightness of the content region.

In an embodiment of the disclosure, the electronic device 100 may set the brightness of the content region to first brightness and the brightness of the area other than the content region to second brightness. The first brightness may be higher or lower than the second brightness.

In an embodiment of the disclosure, the electronic device 100 may set the brightness of the content in the content region of the electronic device 100 to the first brightness, and the brightness of the other area to a value gradually changing from the first brightness to the second brightness. For example, the electronic device 100 may gradually control at least one of the brightness or the reflectivity of the surrounding area of the identified object for the content region to be naturally mingled with the area other than the content region.

In operation 840, the electronic device 100 may set the brightness of each point in the area other than the content region on the mirror display. In an embodiment of the disclosure, the electronic device 100 may set brightness of each point in the area other than the content region on the mirror display to gradually change from the brightness of the content region as the point grows distant from the content region.

In an embodiment of the disclosure, the electronic device 100 may set each point in the area other than the content region on the mirror display to be gradually dark or bright as the point grows distant from the content region. The electronic device 100 may use coordinate information of each pixel in the display region on the mirror display to change the brightness of the point in proportion to the distance of the point to the center or boundary of the content region. For example, the electronic device 100 may set brightness of each point in the area other than the content region in a way that a portion close to the center or boundary of the content region maintains the brightness similar to the content region and that brightness is reduced or increased gradually as a portion is farther from the content region.

In an embodiment of the disclosure, the electronic device 100 may set (e.g., determine) a brightness change value by using a distance between pixels in the content region and the other area. As the distance between a pixel corresponding to an area other than the content region on the mirror display and a pixel corresponding to the content region increases, the electronic device 100 may set (e.g., determine) brightness of the pixel corresponding to the area other than the content region to be gradually changed from the brightness of the content region. The electronic device 100 may change the brightness more smoothly by applying linear changing or nonlinear changing such as the Gaussian function.

For example, the electronic device 100 may use a Gaussian brightness control method to gradually reduce the brightness around the content region and make a distant area abruptly dark, thereby creating a naturally focusable environment.

FIG. 8B is a flowchart for describing an example of controlling brightness of a content region and an area other than the content region, according to an embodiment of the disclosure.

In an embodiment of the disclosure, a first mirror display 850 displays a content 852. The electronic device 100 may identify an object in the content 852. In an embodiment of the disclosure, the electronic device 100 may determine that the object in the content 852 is included in a separate screen frame. In an embodiment of the disclosure, the electronic device 100 may obtain a content region 862 by inpainting the area surrounding the identified content 852.

In an embodiment of the disclosure, a second mirror display 870 may display a content region 872. The electronic device 100 may set (e.g., determine) brightness of an area other than the content region 872 on the second mirror display 870 differently from (e.g., to be higher or lower than) the brightness of the content region 872.

In an embodiment of the disclosure, the electronic device 100 may set (e.g., determine) each point in the area other than the content region 872 on the second mirror display 870 to gradually change from the brightness of the content region 872 as the point grows distant from the content region 872. Accordingly, the electronic device 100 may naturally display the content on the second mirror display 870. In an embodiment of the disclosure, the electronic device 100 may set (e.g., determine) at least one of the brightness of the content region or the brightness of the other area than the content region such that the content and the boundary of the mirror are naturally mingled.

FIG. 9A is a reference diagram for describing relations between brightness and reflectivity of a mirror display, according to an embodiment of the disclosure.

In an embodiment of the disclosure, the brightness of the mirror display may refer to intensity of light emitted by the display. The brightness of the mirror display may determine an extent to which the content displayed on the display is clearly viewed. For example, the brightness of the mirror display increases, the content displayed on the mirror display is viewed more clearly. For example, as the brightness of the mirror display increases, the performance of the mirror display as a display is emphasized.

In an embodiment of the disclosure, reflectivity of the mirror display may refer to a ratio of external light reflecting off the surface of the mirror display. In an embodiment of the disclosure, as the reflectivity of the mirror display increases, the mirror display is able to reflect an object outside of the mirror display better. For example, as the reflectivity of the mirror display increases, the performance of the mirror display as a mirror may be emphasized.

In an embodiment of the disclosure, the brightness and the reflectivity of the mirror display may have a certain relationship. In an embodiment of the disclosure, the brightness and the reflectivity of the mirror display may be inverse proportional.

For example, referring to a table 910, when the reflectivity is reduced by first percentage 912, the brightness may increase by the first percentage 912. For example, when the reflectivity increases by second percentage 914, the brightness may be reduced by the second percentage 914.

For example, referring to the table 910, when the brightness increases by the first percentage 912, the reflectivity may be reduced by the first percentage 912. For example, when the brightness is reduced by the second percentage 914, the reflectivity may increase by the second percentage 914.

Although the brightness and reflectivity are represented by integer values in the table 910 for convenience of explanation, the embodiment of the disclosure is not limited thereto.

FIG. 9B is a reference diagram for briefly describing a principle of a mirror display, according to an embodiment of the disclosure.

In the disclosure, the mirror display may be implemented in various forms. For example, the mirror display may be implemented with a micro LED mirror, a switchable mirror, or other electronic elements including a mirror and a display. How the operation of the electronic device 100 as described above with reference to FIGS. 1 to 9A is implemented with the micro LED mirror will now be briefly described.

A micro LED mirror 920 is a display that is able to provide mirror and display functions simultaneously by using a micro LED technology. The micro LED mirror 920 may include micro LEDs 930, small LED devices in micrometers (μm). For example, the micro LED 930 may be 508 μm across and long, but is not limited thereto. The micro LED 930 may be a self-luminous display that emits light separately. The electronic device 100 may control the individual micro LED 930. The electronic device 100 may display content in a certain region and not display content in other areas by turning on some of the micro LEDs 930 of the micro LED mirror 920. The area where no content is displayed may serve as a mirror.

The micro LED mirror 920 may include a high-mirror coating such as a mirror glass 940 on a panel surface. The micro LED mirror 920 may include the mirror glass 940 to serve as a mirror while the micro LEDs 930 do not emit light (i.e., the display is turned off). The mirror glass 940 may reflect light. When the micro LED element emits light, the light is transmitted through the mirror glass 940 for the content to be displayed on the mirror display 110. The mirror glass 940 may be an aluminum-niobium (Al-Nb) alloy mirror.

The micro LED mirror 920 may be implemented by arranging the micro LEDs 930 on a substrate 950 in a form that enables both light transmission and reflection. When required, the micro LEDs 930 may serve as a display by emitting light. When the micro LEDs 930 do not emit light, the micro LED mirror 920 may serve as a mirror with high reflectivity because no light is transmitted through the micro LED mirror 920. The micro LED 930 may include red, green and blue (RGB) chips.

In an embodiment of the disclosure, the micro LED mirror 920 may have a special structure in which the micro LED mirror 920 is switchable between the mirror and the display through light emission control over the mirror glass 940 and the micro LEDs 930, and materialize reflectivity that fits the use environment by harmonizing the two functions.

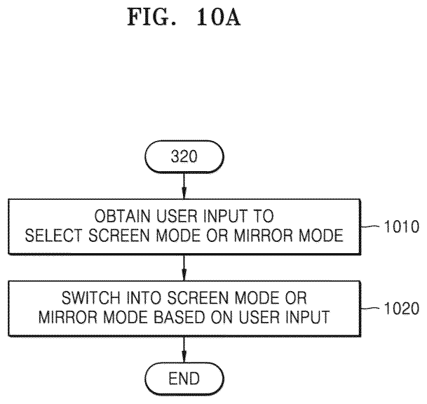

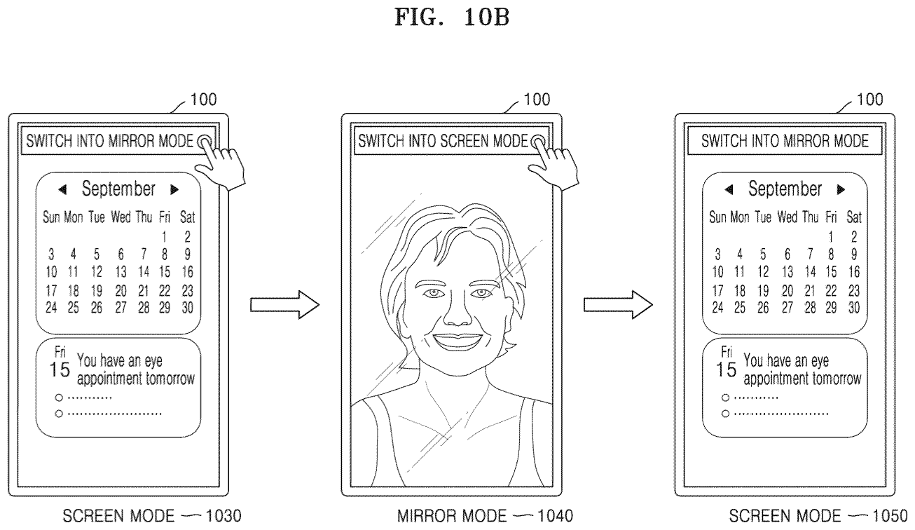

FIG. 10A is a flowchart illustrating a method of controlling a mirror display based on a user input, according to an embodiment of the disclosure.

In operation 1010, the electronic device 100 may obtain a user input. In an embodiment of the disclosure, the electronic device 100 may control (e.g., determine) the brightness of the display region on the mirror display based on the user input.

The electronic device 100 may obtain user inputs through various means. For example, the electronic device 100 may obtain a user input by button clicking, touchscreen manipulation or voice command to the electronic device 100. For example, the electronic device 100 may obtain a user input by receiving a value input to an external electronic device or an external server through a communication interface. For example, the user input may be obtained through the user's physical input to an external device (e.g., pressing a button on a remote controller). For example, the user input may be obtained through a user interface provided by the external device. For example, the user input may be obtained through a user interface provided by the electronic device 100.

In an embodiment of the disclosure, the user input may be to directly control the brightness of the mirror display. In an embodiment of the disclosure, the user input may be to select one of preset brightness modes of the mirror display.

In an embodiment of the disclosure, the electronic device 100 may obtain a user input to select a screen mode that sets the brightness of the display region on the mirror display to be equal to or larger than the reference brightness. In an embodiment of the disclosure, the electronic device 100 may obtain a user input to select a mirror mode that sets the brightness of the display region on the mirror display to be less than the reference brightness.

In operation 1020, the electronic device 100 may switch into the screen mode or the mirror mode based on the user input.

In an embodiment of the disclosure, the electronic device 100 may switch into the screen mode based on a user input. In an embodiment of the disclosure, when the electronic device 100 switches into the screen mode, the brightness of the display region on the mirror display may be changed to the reference brightness or higher. In this case, the mirror display of the electronic device 100 may be used to display content.

In an embodiment of the disclosure, the electronic device 100 may switch into the mirror mode based on a user input. In an embodiment of the disclosure, when the electronic device 100 switches into the mirror mode, the brightness of the display region on the mirror display may be changed to less than the reference brightness. In this case, the electronic device 100 may play a similar role to the mirror.

In an embodiment of the disclosure, the reference brightness may be a basis for switching between the screen mode and the mirror mode on the mirror display. The reference brightness may be adjusted according to the user's setting or may be set in advance.

In an embodiment of the disclosure, the electronic device 100 may control the brightness of the mirror display according to various types of user inputs such as voice command, touch operation, gesture recognition, etc. For example, when the user issues a voice command “screen mode” in front of the electronic device 100, the electronic device 100 is switched into the screen mode and the brightness of the display region on the mirror display may be increased so that the user may check various information such as news, weather, schedule, etc. For example, when the user inputs a command “mirror mode” in front of the electronic device 100, the electronic device 100 may be switched into the mirror mode and reduce the brightness of the display region.

FIG. 10B is a reference diagram for describing an example of controlling a mirror display based on a user input, according to an embodiment of the disclosure.

In operation 1030, the electronic device 100 may be in the screen mode in which the brightness of the display region is equal to or larger than the reference brightness. In operation 1030, the electronic device 100 may obtain a user input to select (or switch to) the mirror mode in which the brightness of the display region is set to be less than the reference brightness. The user input to select (or switch to) the mirror mode may be input to the electronic device 100 through a mechanical button or through a touch screen on the mirror display.

In operation 1040, the electronic device 100 may switch into the mirror mode based on the user input obtained in operation 1030. In an embodiment of the disclosure, the electronic device 100 may set the brightness of the display region on the mirror display to be less than the reference brightness. In an embodiment of the disclosure, the electronic device 100 may increase visibility of a person projected on the mirror of the mirror display by reducing the brightness of the display region on the mirror display.

In operation 1040, the electronic device 100 may be in the mirror mode in which the brightness of the display region is set to be less than the reference brightness. In operation 1040, the electronic device 100 may obtain a user input to select (or switch to) the screen mode in which the brightness of the display region is set to be equal to or larger than the reference brightness.

In operation 1050, the electronic device 100 may switch into the screen mode based on the user input obtained in operation 1040. In an embodiment of the disclosure, the electronic device 100 may set the brightness of the display region on the mirror display to be equal to or larger than the reference brightness. In an embodiment of the disclosure, the electronic device 100 may increase visibility of content displayed on the display of the mirror display by increasing the brightness of the display region on the mirror display.

As described above in connection with FIGS. 10A and 10B, the electronic device 100 may increase the user convenience by controlling the brightness of the display region on the mirror display based on a user input.

How to control the brightness of the mirror display based on a user input as described above in connection with FIGS. 10A and 10B may be used along with the method described above in connection with FIGS. 1 to 9.

For example, when the ambient illumination level of the electronic device 100 is equal to or larger than a threshold illumination level, and the electronic device 100 obtains a user input to select the screen mode, the electronic device 100 may increase the brightness of the display region on the mirror display based on the user input to select the screen mode, but may control the brightness of the display region on the mirror display to be low based on the ambient illumination level (i.e., not to impair the visibility due to too high brightness).

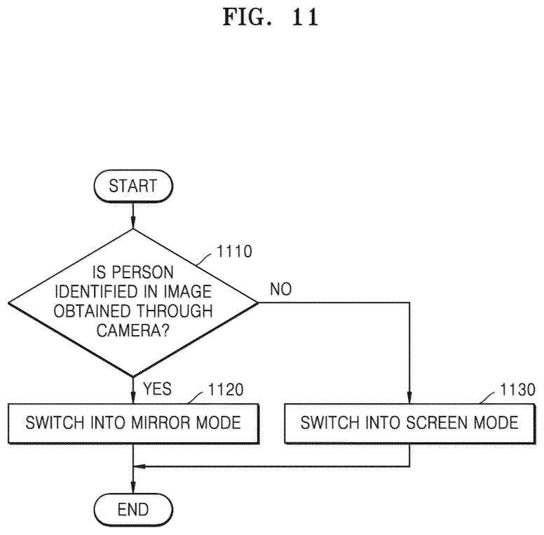

FIG. 11 is a flowchart illustrating a method of controlling a mirror display based on a person being identified in an image, according to an embodiment of the disclosure.

In operation 1110, the electronic device 100 may determine whether a person is identified from an image obtained through a camera. In an embodiment of the disclosure, the electronic device 100 may detect (e.g., identify or determine) whether there is a person in the image obtained through the camera.

In an embodiment of the disclosure, the electronic device 100 may detect (e.g., identify) a human object in the image based on an object detection algorithm. The electronic device 100 may determine (e.g., identify) whether there is a person in the image by using a pre-trained AI model.

In an embodiment of the disclosure, the electronic device 100 may determine whether there is a person in the image by detecting (e.g., identifying) an object based on the silhouette or outline of the person. In an embodiment of the disclosure, the electronic device 100 may determine (e.g., identify or decide) whether there is a person in the image by detecting an object through machine learning.

In operation 1120, based on a person being identified by the electronic device 100 from the image obtained through the camera, the electronic device 100 may determine that there is a person in front of the electronic device 100. The electronic device 100 may control the brightness of the display region on the mirror display based on the determining that there is a person in front of the electronic device 100.

In an embodiment of the disclosure, the electronic device 100 may set (e.g., determine) the brightness of the display region on the mirror display of the electronic device 100 to be less than the reference brightness based on the determining that a person is identified from the image obtained through the camera (operation 1130). The electronic device 100 may switch into the mirror mode. Based on the identifying of a person, the electronic device 100 may control the brightness of the display region on the mirror display, thereby increasing the user's convenience through the brightness control for the electronic device 100 even without a direct input from the user. The mirror mode is described above in connection with FIGS. 10A and 10B, so the description thereof will not be repeated for the sake of brevity.

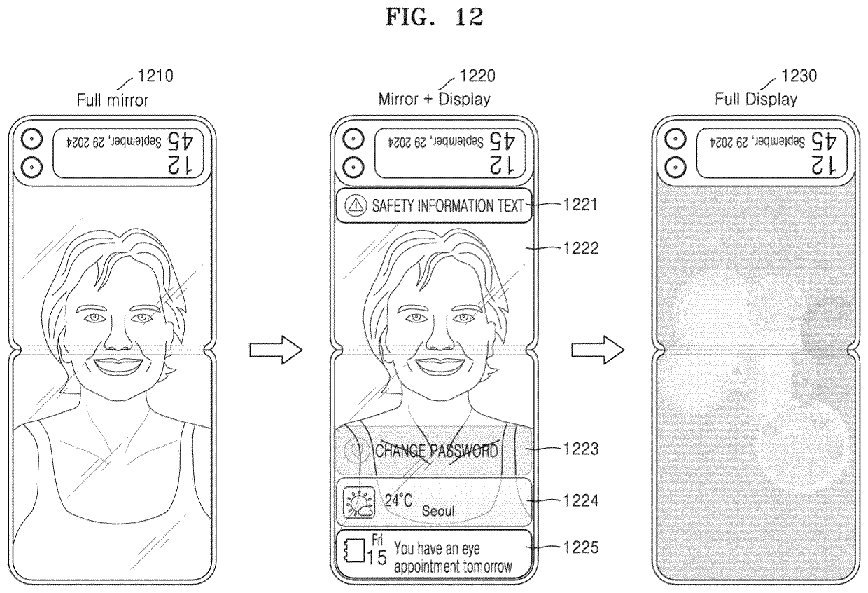

FIG. 12 is a reference diagram for describing an example of controlling an electronic device for each section, according to an embodiment of the disclosure.

The electronic device 100 may include a mirror display on at least one of the front side or the rear side of the electronic device 100. For example, when the electronic device 100 is a cell phone, the display of the cell phone may correspond to the mirror display, or the display of the cell phone is an ordinary display and an external cover of the cell phone may include the mirror display.

In an embodiment of the disclosure, the whole or part of the display of the electronic device 100 may be configured as the mirror display. In an embodiment of the disclosure, the whole or part of an external cover of the electronic device 100 may include the mirror display.

For example, the mirror display may be included only on the upper external cover, the lower external cover, or both the upper and lower external covers of the electronic device 100. For example, the mirror display may also be included in a portion connecting the upper part and the lower part of the electronic device 100. For example, the mirror display may not be included in the portion connecting the upper part and the lower part of the electronic device 100.

For example, even when the electronic device 100 has an integral external cover, the whole or part of the external cover may include the mirror display.

In operation 1210, the electronic device 100 may set the brightness of the whole display region on the mirror display to be less than the reference brightness. In an embodiment of the disclosure, the electronic device 100 may use the entire mirror display for the mirror mode.

In an embodiment of the disclosure, the electronic device 100 may use the entire mirror display for the mirror mode based on a proportion occupied by the content region displayed in the display region on the mirror display. For example, the electronic device 100 may use the entire mirror display for the mirror mode based on the proportion occupied by the content region displayed in the display region on the mirror display being less than the threshold proportion.

In an embodiment of the disclosure, the electronic device 100 may display (or, project or reflect) an object in front of the electronic device 100 onto the electronic device 100. For example, the electronic device 100 may display (or, project or reflect) the user in front of the electronic device 100 onto the electronic device 100.

In an embodiment of the disclosure, the electronic device 100 may set the brightness of an area other than the person area on the mirror display differently from the brightness of the person area as the electronic device 100 recognizes the person. In an embodiment of the disclosure, the electronic device 100 may set the brightness of each point in the area other than the person area on the mirror display to be gradually changed from the brightness of the person area as the point grows distant from the person area. The embodiment of using the display region on the mirror display of the electronic device 100 for the mirror mode is as described above, so the description thereof will not be repeated for the sake of brevity.

In operation 1220, the electronic device 100 may set the brightness of the display region on the mirror display to be many different values. In an embodiment of the disclosure, the electronic device 100 may divide the display region on the mirror display into multiple sections, and determine the brightness of the divided multiple sections to have multiple different values. In an embodiment of the disclosure, the electronic device 100 may divide the display region on the mirror display into multiple sections, and determine the reflectivity of the divided multiple sections to have multiple different values.

For example, the electronic device 100 may set the brightness of a first section of the display region on the mirror display to a first brightness and the brightness of a second section to a second brightness. For example, the electronic device 100 may set the brightness of the first section of the display region on the mirror display to the first brightness, the brightness of the second section to the second brightness, the brightness of a third section to a third brightness, and the brightness of a fourth section to a fourth brightness.

In an embodiment of the disclosure, the electronic device 100 may set the reflectivity of the first section of the display region on the mirror display to a first reflectivity and the reflectivity of the second section to a second reflectivity. For example, the electronic device 100 may set the reflectivity of the first section of the display region on the mirror display to the first reflectivity, the reflectivity of the second section to the second reflectivity, the reflectivity of a third section to a third reflectivity, and the reflectivity of a fourth section to a fourth reflectivity.

Accordingly, the electronic device 100 may control the brightness or the reflectivity of each section of the display region on the mirror display. The electronic device 100 may enhance the visual information delivery function by clearly displaying (or outputting) content in an area farther from the person area in the display region on the mirror display, and provide more natural viewing experience for the user by clearly displaying (or projecting or reflecting) the person in an area closer from the person area.

For example, the electronic device 100 may set the brightness and the reflectivity of a first section 1221 of the display region on the mirror display to 100% and 0%, respectively. The electronic device 100 may clearly represent the content displayed (or output) in the first section 1221. The electronic device 100 may not display the person projected in the first section 1221. The electronic device 100 may set the first section 1221 into the screen mode to clearly represent the content as soon as the mirror function is deactivated. External light or a person's image may not be reflected off from the first section 1221. The electronic device 100 may allow the user to concentrate only on the screen information in the first section 1221 by having the content output onto the mirror display visually concentrated and preventing projection of a person.

In an embodiment of the disclosure, the electronic device 100 may set the brightness and the reflectivity of a second section 1222 of the display region on the mirror display to 0% and 100%, respectively. The electronic device 100 may control the second section 1222 to be set into the mirror mode to clearly reflect a person or object as a mirror as soon as the display function is deactivated. The electronic device 100 may clearly represent the person or object reflected off from (or projected onto) the second section 1222. The electronic device 100 may not display content included (or output) in the second section 1222.

In an embodiment of the disclosure, the electronic device 100 may set the brightness and the reflectivity of a third section 1223 of the display region on the mirror display to 30% and 70%, respectively. The electronic device 100 may set the third section 1223 into a mirror and screen combined mode (e.g., hybrid mode). The electronic device 100 may represent a person reflected from (or projected onto) the third section 1223 and content included (or output) in the third section 1223 at the same time. The electronic device 100 may represent a person reflected from (or projected onto) the third section 1223 and blurredly (or at a brightness lower than the first section, a fourth section or a fifth section) display the content included (or output) in the third section 1223 as well. The electronic device 100 may set the third section 1223 into the mirror and screen combined mode to display information in a blurred form while representing the person through the mirror display.

In an embodiment of the disclosure, the electronic device 100 may set the brightness and the reflectivity of a fourth section 1224 of the display region on the mirror display to 70% and 30%, respectively. The electronic device 100 may represent a person reflected from (or projected onto) the fourth section 1224 and content included (or output) in the fourth section 1224 at the same time. The electronic device 100 may set the fourth section 1224 into the mirror and screen combined mode (e.g., hybrid mode). The electronic device 100 may represent a person reflected from (or projected onto) the fourth section 1224 and blurredly (or at a brightness lower than the first section or a fifth section) display the content included (or output) in the fourth section 1224 as well. The electronic device 100 may represent the content displayed in the fourth section 1224 more clearly than the content displayed in the third section 1223.

For example, the electronic device 100 may set the brightness and the reflectivity of a fifth section 1225 of the display region on the mirror display to 100% and 0%, respectively. The electronic device 100 may clearly represent the content displayed (or output) in the fifth section 1225. The electronic device 100 may not display the person projected in the fifth section 1225. The electronic device 100 may set the fifth section 1225 into the screen mode to clearly represent the content as soon as the mirror function is deactivated. External light or a person's image may not be reflected off from the fifth section 1225. The electronic device 100 may allow the user to concentrate only on the screen information in the fifth section 1225 by having the content output onto the mirror display visually concentrated and preventing projection of a person.

In an embodiment of the disclosure, the electronic device 100 may set different (or customize) brightness and reflectivity for each section of the display region on the mirror display depending on the user's preference or need. Accordingly, the electronic device 100 may optimize the user's experience.

In operation 1230, the electronic device 100 may set the brightness of the whole display region on the mirror display to be equal to or larger than the reference brightness. In an embodiment of the disclosure, the electronic device 100 may use the entire mirror display for the screen mode.

In an embodiment of the disclosure, the electronic device 100 may use the entire mirror display for the screen mode based on a proportion occupied by the content region displayed in the display region on the mirror display. For example, the electronic device 100 may use the entire mirror display for the screen mode based on the proportion occupied by the content region displayed in the display region on the mirror display being equal to or larger than the threshold proportion.

In an embodiment of the disclosure, the electronic device 100 may display the content of the electronic device 100 onto the electronic device 100. For example, the electronic device 100 may display at least one of a photo, an image, a game, an ambient art or a content of an application processed by the processor 130 of the electronic device 100 on the electronic device 100. The embodiment of using the display region on the mirror display of the electronic device 100 for the screen mode is as described above, so the description thereof will not be repeated for the sake of brevity.

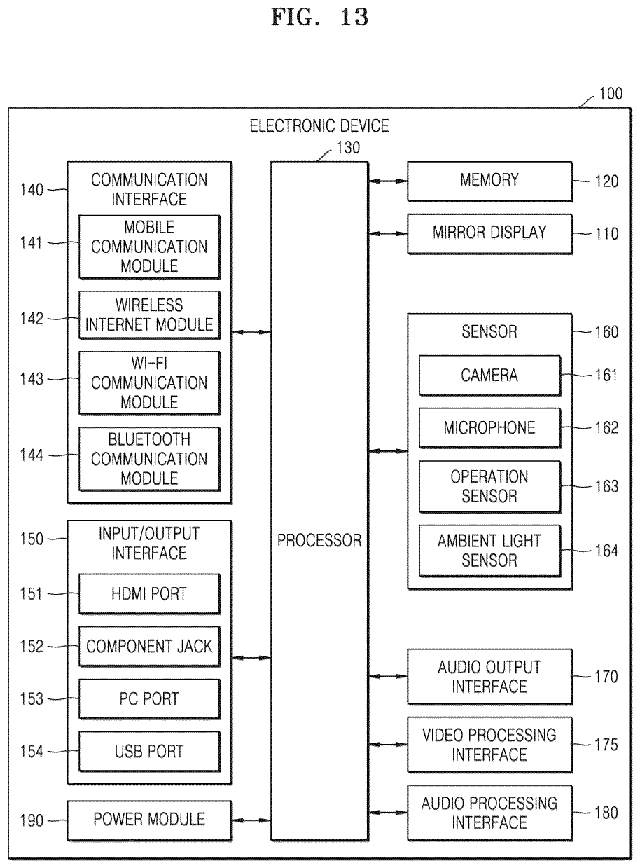

FIG. 13 is a block diagram illustrating a configuration of an electronic device, according to an embodiment of the present disclosure.

In an embodiment of the disclosure, the electronic device 100 may include the memory 120, the processor 130, the mirror display 110, a communication interface 140, an input/output interface 150, a sensor 160, an audio output interface 170, a video processing interface 175, an audio processing interface 180 and a power module 190. The electronic device 100 may be configured with various combinations of the components shown in FIG. 13, but not all the components shown in FIG. 13 are essential.

The mirror display 110 may output an image signal on the screen of the electronic device 100 under the control of the processor 130. For example, the electronic device 100 may output a content through the mirror display 110. The mirror display 110 may convert an image signal, a data signal, an on-screen display (OSD) signal, a control signal, etc., processed by the processor 130 into a driving signal, and display an image according to the driving signal.

The mirror display 110 may include one of a liquid crystal display, a plasma display, an organic LED display and an inorganic LED display. The disclosure is not, however, limited thereto, and the mirror display 110 may include a different type of display that is able to display the content.

The memory 120 may store a program related to operations of the electronic device 100 and various data generated during the operation of the electronic device 100. The memory 120 may store at least one instruction. The memory 120 may store the at least one instruction to be executed by the processor 130. The memory 120 may also store at least one program to be executed by the processor 130. The memory 120 may also store an application to provide a certain service.

The memory 120 may include various types of memories. The memory 120 may include a main memory for storing data being currently processed by the electronic device 100. For example, the main memory may include a non-volatile memory including at least one of a read-only memory (ROM), an electrically erasable programmable ROM (EEPROM) or a programmable ROM (PROM), and a volatile memory such as a random access memory (RAM) or a static RAM (SRAM).

The memory 120 may include a secondary memory for permanently storing massive-volume data (e.g., a program a system file, etc.). For example, the secondary memory may include a hard disk drive (HDD), a solid state drive (SSD), an optical drive (e.g., a compact disc), a flash drive, etc., without being limited thereto.

The processor 130 may control general operations of the electronic device 100. For example, the processor 130 may perform a function of the electronic device 100 as described in the disclosure by executing one or more instructions stored in the memory 120 individually or collectively. The processor 130 may include a processing circuit. There may be one or more processors 130.

In an embodiment of the disclosure, the processor 130 may have a built-in memory that stores one or more instructions and execute the one or more instructions stored in the built-in memory to perform operations of the electronic device 100. In other words, the processor 130 may execute at least one instruction or program stored in the built-in memory equipped in the processor 130 or the memory 120 to perform an operation.

In an embodiment of the disclosure, the processor 130 may perform the operations of the electronic device 100 as described in the disclosure by executing one or more instructions stored in the memory 120.

The processor 130 may include at least one of e.g., a CPU, a microprocessor, a GPU, an application specific integrated circuit (ASIC), a digital signal processor (DSP), a digital signal processing device (DSPD), a programmable logic device (PLD), a field programmable gate array (FPGA), an AP, an NPU or an AI specific processor designed in a hardware structure specialized in processing of an AI model, without being limited thereto.

The communication interface 140 may perform data communication with other electronic devices (e.g., a server) under the control of the processor 130. The term communication may refer to an operation of transmitting and/or receiving data, signals, a request and/or a command. The communication interface 140 may include a communication circuit.

The communication interface 140 may perform wired or wireless communication with at least one external device. The external device may be, e.g., a server. For example, the communication interface 140 may include at least one of a communication module, a communication circuit, a communication device, an input/output port or an input/output plug to perform wired or wireless communication with at least one external device.

The communication interface 140 may include one or more modules that allow wired/wireless communication between the electronic device 100 and a wireless communication system or between the electronic device 100 and a network in which another electronic device is located. For example, the communication interface 140 may include a mobile communication module 141, a wireless Internet module 142, a Wi-Fi communication module 143 and a Bluetooth communication module 144.

The mobile communication module 141 transmits or receives wireless signals to or from at least one of a base station, an external terminal, or a server in a mobile communication network. The wireless signal may include a voice call signal, a video call signal or different types of data involved in transmission/reception of a text/multimedia message.

The wireless Internet module 142 refers to a module for wireless Internet access, which may be built inside or outside the device. The wireless Internet technology may employ wireless LAN (WLAN), Wi-Fi, wireless broadband (Wibro), world interoperability for microwave access (Wimax), high speed downlink packet access (HSDPA), etc. The electronic device 100 may make Wi-Fi peer-to-peer (P2P) connection with another electronic device through the wireless Internet module 142.

The communication interface 140 may include a short-range communication module for short-range communication. For the short-range communication technology, Bluetooth, Bluetooth low energy (BLE), Radio Frequency Identification (RFID), infrared Data Association (IrDA), Ultra Wideband (UWB), ZigBee, etc. may be used. The communication interface 140 may include a Wi-Fi communication module 143 and a Bluetooth communication module 144 as the short-range communication module.

The input/output interface 150 processes inputs/outputs from outside the electronic device 100. The input/output interface 150 receives a video (e.g., a moving image), an audio (e.g., a speech, music, etc.), additional information (e.g., an EPG), or the like. The input/output interface 150 may include at least one of a high-definition multimedia interface (HDMI) port 151, a component jack 152, a personal computer (PC) port 153, a universal serial bus (USB) port 154, a mobile high-definition link (MHL), a display port (DP), Thunderbolt, a video graphics array (VGA) port, an RGB port, a D-subminiature (D-SUB), a digital visual interface (DVI), or an audio jack. In an embodiment of the disclosure, the input/output interface 150 may be implemented to include a plurality of modules (e.g., the USB port, an HDMI port, etc.) to materialize the aforementioned input/output methods. The electronic device 100 may be connected to external devices such as a display, a camera, a microphone, a speaker, a touch pad, a set-top box, etc., through the input/output interface 150.

A sensor 160 may obtain sensor data. There may be one or more sensors 160. The sensor 160 may detect an ambient illumination level, presence/absence of the user, or a behavior of the user. The processor 130 may obtain information by processing the sensor data. The sensor 160 may include the camera 161, a microphone 162, an operation sensor 163 and an ambient light sensor 164. The sensor 160 may transmit the obtained sensor value to the processor 130. The processor 130 may obtain information about a surrounding environment of the electronic device by performing a certain process on the obtained sensor value. The electronic device 100 may control the brightness of the display region on the mirror display based on the obtained information about the surrounding environment. To the extent a function performed by each component of the sensor 160 is implied by the name, the description thereof will be omitted for the sake of brevity.

The audio output interface 170 may output audio, e.g., voice or sound, input through the communication interface 140 or the input/output interface 150. Furthermore, the audio output interface 170 may output audio stored in the memory 120 under the control of the processor 130. The audio output interface 170 may include at least one or a combination of a speaker, a headphone output terminal or a Sony/Philips digital interface (S/PDIF).

The video processing interface 175 processes video data played by the electronic device 100. The video processing interface 175 may perform various image/video processes such as decoding, scaling, noise filtering, frame rate conversion, resolution conversion, rendering, etc., on the video data.

The audio processing interface 180 processes audio data played by the electronic device 100. The audio processing interface 180 may perform various processes such as decoding, amplification, noise filtering, etc., on the audio data.

The power module 190 supplies power received from an external power source to the components in the electronic device 100 that operates under the control of the processor 130. Furthermore, the power module 190 may supply power output from one or more batteries located in the electronic device 100 to the internal components under the control of the processor 130.

According to an embodiment of the disclosure, an electronic device includes memory storing at least one instruction and at least one processor including processing circuitry. The at least one processor may individually or collectively execute the at least one instruction to cause the electronic device to identify a proportion occupied by a content region displayed in a display region on the mirror display. The at least one processor may individually or collectively execute the at least one instruction to cause the electronic device to control the mirror display to control brightness of the display region on the mirror display based on the proportion occupied by the content region in the display region.

The at least one processor may individually or collectively execute the at least one instruction to cause the electronic device to control the mirror display so that brightness of the display region on the mirror display is equal to or larger than a reference brightness based on the proportion occupied by the content region in the display region being equal to or larger than a threshold proportion. The at least one processor may individually or collectively execute the at least one instruction to cause the electronic device to control the mirror display so that brightness of the display region is less than the reference brightness based on the proportion occupied by the content region in the display region being less than the threshold proportion.

The electronic device may include a camera. The at least one processor may individually or collectively execute the at least one instruction to cause the electronic device to obtain an image through the camera. The at least one processor may individually or collectively execute the at least one instruction to cause the electronic device to identify a person area projected onto the mirror display based on the image. The at least one processor may individually or collectively execute the at least one instruction to cause the electronic device to set brightness of an area other than the person area on the mirror display differently from brightness of the person area.

The at least one processor may individually or collectively execute the at least one instruction to cause the electronic device to set brightness of a pixel corresponding to the area other than the person area to gradually change from the brightness of the person area as a distance between the pixel corresponding to the area other than the person area on the mirror display and a pixel corresponding to the person area increases.

The at least one processor may individually or collectively execute the at least one instruction to cause the electronic device to control brightness of the display region on the mirror display based on a sensor value obtained by the ambient light sensor.

The at least one processor may individually or collectively execute the at least one instruction to cause the electronic device to control brightness of the display region on the mirror display when the sensor value obtained by the ambient light sensor is equal to or greater than a threshold illumination level. The at least one processor may individually or collectively execute the at least one instruction to cause the electronic device to control brightness of the display region on the mirror display to be increased when the sensor value obtained by the ambient light sensor is less than the threshold illumination level.

The at least one processor may individually or collectively execute the at least one instruction to cause the electronic device to identify an object in a content. The at least one processor may individually or collectively execute the at least one instruction to cause the electronic device to obtain a content region by inpainting an area surrounding the identified object. The at least one processor may individually or collectively execute the at least one instruction to cause the electronic device to set brightness of an area other than the content region on the mirror display differently from brightness of the content region.

The at least one processor may individually or collectively execute the at least one instruction to cause the electronic device to set brightness of a pixel corresponding to the area other than the content region to gradually change from the brightness of the content region as a distance between the pixel corresponding to the area other than the content region on the mirror display and a pixel corresponding to the content region increases.

The at least one processor may individually or collectively execute the at least one instruction to cause the electronic device to obtain a projection image projected onto the mirror display from the image obtained by the camera. The at least one processor may individually or collectively execute the at least one instruction to cause the electronic device to identify the person area in the projection image.

The at least one processor may individually or collectively execute the at least one instruction to cause the electronic device to obtain a user input to select a screen mode in which brightness of the display region is set to be equal to or larger than the reference brightness or a mirror mode in which the brightness of the display region is set to be less than the reference brightness. The at least one processor may individually or collectively execute the at least one instruction to cause the electronic device to switch into the screen mode or the mirror mode based on the user input.

The at least one processor may individually or collectively execute the at least one instruction to cause the electronic device to determine whether a person is identified in the image obtained through the camera. The at least one processor may individually or collectively execute the at least one instruction to cause the electronic device to switch into the mirror mode based on the determining that the person is identified.

According to an embodiment of the disclosure, a method of operating an electronic device includes identifying a proportion occupied by a content region displayed in a display region on a mirror display. The method may include controlling the mirror display to control brightness of the display region on the mirror display based on the proportion occupied by the content region in the display region.

The method may include controlling the mirror display so that the brightness of the display region on the mirror display is equal to or larger than a reference brightness based on the proportion occupied by the content region in the display region being equal to or larger than a threshold proportion. The method may include controlling the mirror display so that the brightness of the display region on the mirror display is less than the reference brightness based on the proportion occupied by the content region in the display region being less than the threshold proportion.

The method may include obtaining an image through a camera. The method may include identifying a person area projected onto the mirror display based on the image. The method may include setting brightness of an area other than the person area on the mirror display differently from brightness of the person area.

The method may include setting brightness of a pixel corresponding to the area other than the person area to gradually change from the brightness of the person area as a distance between the pixel corresponding to the area other than the person area and a pixel corresponding to the person area increases.

The method may include controlling brightness of the display region on the mirror display based on a sensor value obtained by an ambient light sensor.

The method may include controlling the brightness of the display region on the mirror display to be reduced, when the sensor value obtained by the ambient light sensor is equal to or greater than a threshold illumination level. The method may include controlling the brightness of the display region on the mirror display to be increased when the sensor value obtained by the ambient light sensor is less than the threshold illumination level.

The method may include identifying an object in a content. The method may include obtaining a content region by inpainting an area surrounding the identified object. The method may include setting brightness of an area other than the content region on the mirror display differently from brightness of the content region.

The method may include setting brightness of a pixel corresponding to the area other than the content region to gradually change from the brightness of the content region as a distance between the pixel corresponding to the area other than the content region and a pixel corresponding to the content region increases.

The method may include obtaining a projection image projected onto the mirror display from the image obtained by the camera. The method may include identifying the person area in the projection image.

The method may include obtaining a user input to select a screen mode in which the brightness of the display region is set to be equal to or greater than the reference brightness or a mirror mode in which the brightness of the display region is set to be less than the reference brightness. The method may include switching into the screen mode or the mirror mode based on the user input.

The method may include determining whether a person is identified in the image obtained through the camera. The method may include switching into the mirror mode based on the determining that the person is identified.

One or more embodiments of the disclosure may be implemented in the form of a computer-readable recording medium that includes computer-executable instructions such as the program modules executed by the computer. The computer-readable medium may be an arbitrary available medium that may be accessed by the computer, including volatile, non-volatile, removable, and non-removable mediums. The computer-readable medium may also include a computer storage medium. The computer-readable medium includes all the volatile, non-volatile, removable, and non-removable mediums implemented by an arbitrary method or technology for storage of information, such as computer-readable instructions, data structures, program modules, or other data.

Embodiments of the disclosure may be implemented with a software program including instructions stored in a computer-readable storage medium.

The computer is a device capable of calling out instructions stored in a storage medium and operating under the instructions as in the embodiments of the disclosure, and may include an electronic device according to the embodiments of the disclosure.

The computer-readable storage medium may be provided in the form of a non-transitory storage medium. The term ‘non-transitory’ only means that the storage medium is tangible without including a signal, but does not help distinguish any data stored semi-permanently or temporarily in the storage medium.

Furthermore, the control methods according to embodiments of the disclosure may be included and provided in a computer program product. The computer program product may be a commercial product that may be traded between a seller and a buyer.

The computer program product may include a software program and a computer-readable storage medium having the software program stored thereon. For example, the computer program product may include a product in the form of a software program that is electronically distributed by the manufacturer of the device or by an electronic market (e.g., Google play store®, or App store®). For the electronic distribution, at least a portion of the software program may be stored in a storage medium or arbitrarily created. In this case, the storage medium may be one of a server of the manufacturer or of a relay server that temporarily stores the software program.

In a system including a server and a device, the computer program product may include a storage medium of the server or a storage medium of the device. Alternatively, when there is a third device (e.g., a smart phone) communicatively connected to the server or the device, the computer program product may include a storage medium of the third device. In another example, the computer program product may be transferred from the server to the device or the third party, or may include a software program itself that is transferred from the third device to the device.

In this case, one of the server, the device, and the third device may execute the computer program product to perform the method according to the embodiments of the disclosure. Alternatively, two or more of the server, the device, and the third device may execute the computer program product to perform the method according to the embodiments of the disclosure in a distributed fashion.

For example, the server (e.g., a cloud server or an AI server) may execute the computer program product stored therein to control the device communicatively connected to the server to perform the method according to the embodiments of the disclosure.

In yet another example, the third device may execute the computer program product to control the device communicatively connected to the third device to perform the method according to the embodiments of the disclosure. In the case that the third device executes the computer program product, the third device may download the computer program product and execute the downloaded computer program product. Alternatively, the third device may execute the computer program product that is preloaded to perform the method according to the embodiments of the disclosure.

In the specification, the term “interface” may refer to a hardware component such as a processor or a circuit, and/or a software component executed by the hardware component such as the processor.

Several embodiments have been described, but a person of ordinary skill in the art will understand and appreciate that various modifications can be made without departing the scope of the present disclosure. Thus, it will be apparent to those of ordinary skill in the art that the present disclosure is not limited to the embodiments described, but can encompass not only the appended claims but the equivalents. For example, an element described in the singular form may be implemented as being distributed, and elements described in a distributed form may be implemented as being combined.

The scope of the present disclosure is defined by the appended claims, and it will be understood by those of ordinary skill in the art that various changes in form and details may be made without departing from the spirit and scope of the present disclosure as defined by the appended claims and their equivalents.

What is claimed is:

1. An electronic device comprising:
a mirror display comprising a display region;
memory storing at least one instruction; and
at least one processor including processing circuitry,
wherein the at least one instruction, when executed by the at least one processor individually or collectively, cause the electronic device to:
identify a proportion of the display region occupied by a content region, and
control a brightness of the display region based on the proportion.

2. The electronic device of claim 1, wherein the at least one instruction, when executed by the at least one processor individually or collectively, further causes the electronic device to:
based on the proportion being equal to or greater than a threshold proportion, control the brightness of the display region to be equal to or greater than a reference brightness, and
based on the proportion being less than the threshold proportion, control the brightness of the display region to be less than the reference brightness.

3. The electronic device of claim 1, further comprising:
a camera,
wherein the at least one instruction, when executed by the at least one processor individually or collectively, further causes the electronic device to:
obtain an image through the camera,
identify, based on the image, a person area of the mirror display corresponding to a reflection of a person, and
set a brightness of an area of the mirror display other than the person area differently from a brightness of the person area.

4. The electronic device of claim 3, wherein the at least one instruction, when executed by the at least one processor individually or collectively, further causes the electronic device to set the brightness of the area of the mirror display other than the person area such that the brightness of the area of the mirror display other than the person area changes along a gradient moving away from the person area.

5. The electronic device of claim 1, further comprising:
an ambient light sensor,
wherein the at least one instruction, when executed by the at least one processor individually or collectively, further causes the electronic device to control the brightness of the display region based on a sensor value obtained through the ambient light sensor.

6. The electronic device of claim 5, wherein the at least one instruction, when executed by the at least one processor individually or collectively, further causes the electronic device to:
based on the sensor value obtained through the ambient light sensor being equal to or greater than a threshold ambient light level, reduce the brightness of the display region, and
based on the sensor value obtained through the ambient light sensor being less than the threshold ambient light level, increase the brightness of the display region.

7. The electronic device of claim 1, wherein the at least one instruction, when executed by the at least one processor individually or collectively, further causes the electronic device to:
identify an object in content,
obtain the content region by inpainting an area surrounding the identified object, and
set a brightness of an area of the mirror display other than the content region differently from a brightness of the content region.

8. The electronic device of claim 7, wherein the at least one instruction, when executed by the at least one processor individually or collectively, further causes the electronic device to set the brightness of the area of the mirror display other than the content region such that the brightness of the area of the mirror display other than the content region changes along a gradient moving away from the content region.

9. The electronic device of claim 3, wherein the at least one instruction, when executed by the at least one processor individually or collectively, further causes the electronic device to:
obtain a projection image projected onto the mirror display based on the image obtained by the camera, and
identify the person area in the projection image.

10. The electronic device of claim 2, wherein the at least one instruction, when executed by the at least one processor individually or collectively, further causes the electronic device to:
obtain a user input selecting a screen mode in which the brightness of the display region is set to be equal to or greater than the reference brightness or a mirror mode in which the brightness of the display region is set to be less than the reference brightness, and
switch to the screen mode or the mirror mode based on the user input.

11. The electronic device of claim 3, wherein the at least one instruction, when executed by the at least one processor individually or collectively, further causes the electronic device to:
based on determining that a person is identified in the image obtained through the camera, switch to a mirror mode.

12. A method of operating an electronic device, the method comprising:
identifying a proportion of a display region of a mirror display occupied by a content region; and
controlling a brightness of the display region based on the proportion.

13. The method of claim 12, wherein the controlling the brightness of the display region further comprises:
based on the proportion being equal to or greater than a threshold proportion, controlling the brightness of the display region to be equal to or greater than a reference brightness; and
based on the proportion being less than the threshold proportion, controlling the brightness of the display region to be less than the reference brightness.

14. The method of claim 12, further comprising:
obtaining an image through a camera of the electronic device;
identifying, based on the image, a person area of the mirror display corresponding to a reflection of a person; and
setting a brightness of an area of the mirror display other than the person area differently from a brightness of the person area.

15. The method of claim 14, further comprising:
setting the brightness of the area of the mirror display other than the person area such that the brightness of the area of the mirror display other than the person area changes along a gradient moving away from the person area.

16. The method of claim 12, further comprising:
controlling the brightness of the display region based on a sensor value obtained through an ambient light sensor of the electronic device.

17. The method of claim 16, wherein the controlling the brightness of the display region based on the sensor value obtained by the ambient light sensor comprises:
based on the sensor value obtained through the ambient light sensor being equal to or greater than a threshold ambient light level, reducing the brightness of the display region; and
based on the sensor value obtained through the ambient light sensor being less than the threshold ambient light level, increasing the brightness of the display region.

18. The method of claim 12, further comprising:
identifying an object in content;
obtaining the content region by inpainting an area surrounding the identified object; and
setting a brightness of an area of the mirror display other than the content region differently from a brightness of the content region.

19. A non-transitory computer-readable medium having at least one instruction recorded therein, which when executed by at least one processor of an electronic device, causes the electronic device to perform a method of operating the electronic device, the method comprising:
identifying a proportion of a display region of a mirror display occupied by a content region; and
controlling a brightness of the display region based on the proportion.

20. An electronic device comprising:
a mirror display comprising a display region;
an ambient light sensor;
a camera;
memory storing at least one instruction; and
at least one processor including processing circuitry,
wherein the at least one processor is configured to individually or collectively execute the at least one instruction, and
wherein the at least one instruction, when executed by the at least one processor individually or collectively, cause the electronic device to:
identify a proportion of the display region occupied by a content region, and
control a brightness of the display region based on the proportion and at least one of a sensor value obtained through the ambient light sensor, a user input selecting a screen mode of the mirror display, or a determination that a person is identified in an image captured by the camera.
